(19) United States
(12) Patent Application Publication
(10) Pub. No.: US 2009/0305888 A1
(43) Pub. Date: Dec. 10, 2009

(54) Materials and Methods for Providing Oxygen to Improve Seed Germination and Plant Growth

(76) Inventors: Yuncong Li, Homestead, FL (US); Guodong Liu, Homestead, FL (US); D. Marshall Porterfield, W. Lafayette, IN (US)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/162,350

(22) PCT Filed: Jan. 29, 2007
(86) PCT No.: PCT/US07/02200

§ 371 Date: Dec. 13, 2008

Related U.S. Application Data
(60) Provisional application No. 60/762,773, filed on Jan. 27, 2006.

(51) Int. Cl. C05F 11/08; C05F 11/00; C05D 9/00; A01N 59/00

(52) U.S. Cl. 504/101; 71/6; 71/11; 71/63; 71/27

(57) ABSTRACT

The present invention provides compositions and methods for resolving bioavailable oxygen supply to plants subjected to hypoxic stresses. Compositions of the invention comprise an oxidizing agent, wherein the level and rate of oxygen released from the composition is controlled. Use of the compositions of the invention address hypoxic stress and also stimulate plant growth, enhance plant vigor, and/or improve crop yield.

### CROSS-REFERENCE TO RELATED APPLICATIONS

This application claims the benefit of U.S. Provisional Application Ser. No. 60/762,773, filed on Jan. 27, 2006, which is incorporated herein by reference.

### GOVERNMENT SUPPORT

The subject matter of this application has been supported by a research grant from the U.S. Department of Agriculture, Grant No. NRICGP 2001-35100-10751. Accordingly, the government may have certain rights in this invention.

### BACKGROUND OF THE INVENTION

In the United States from 1981 to 2000, there were 719 presidentially-declared disasters and more than 80% of these were flood-related. For example, Hurricane Floyd in September 1999 resulted in flooding in 13 states and $6 billion in damage. Periodic flooding during the growing season adversely affects crop growth and production in many parts of the world (see Schaffer, B., “Flood tolerance of Tahiti Lime rootstocks in South Florida soil,” Proc. Fla. State Hort. Soc., 104:31-32 (1991); Schaffer, B., “Flooding responses and water-use efficiency of subtropical and tropical fruit trees in an environmentally-sensitive wetland,” Annals of Botany., 81:475-481 (1998); and Stanley et al., “Soybean top and root response to temporary water tables imposed at three different stages of growth,” Agron. J., 72:341-346 (1980); and Oosterhuis, D. M. et al., “Physiological response of two soybean [Glycine max, L. Merr] cultivars to short-term flooding,” Env. Exp. Bot., 30:85-92 (1990)).

Lack of oxygen or anoxia is a common environmental challenge that plants have to face throughout their life. This problem is particularly prevalent in many states in America. In Florida, hurricanes cause heavy rains which in turn initiate flooding very often. Flooding from recent hurricanes Charley and Frances (September 2004) damaged over 500,000 acres of citrus and vegetable crops in Florida. A USDA report estimated nearly $900 million in Hurricane Katrina-related crop losses in August 2005. In Miami-Dade County alone, agricultural loss estimates from flooding as a result of excessive rainfall in December 2000 was 13 million dollars. In October 1999, vegetable crop losses due to hurricane Irene were estimated to be about 77 million dollars with nearly 19 thousand acres damaged by floods. Indiana, Illinois, and Missouri, where substantial rainfall in the spring can severely reduce seed germination.

In Western Australia, waterlogging causes 50% or more of losses in crop yield (Dennis, E. et al, “Molecular strategies for improving waterlogging tolerance in plants,” J. Experimental Bot., 51(342):89-97 (2000)). The adverse effects of excess water in farmland soils, such as from flooding or waterlogging of the farming establishment, on yield of agricultural crops are well documented (Drew M C, “Soil aeration and plant root metabolism,” Soil Sci., 154:259-268 (1992); and Drew, M C and Lynch, J M, “Soil anaerobiosis, microorganisms and root function,” Ann Rev Phytopathol, 18:37-66 (1980). “Hypoxic stresses” refer to conditions that induce a severe lack of oxygen or anoxia in plants. In the past few decades, research has provided a great deal of information regarding the morphological, anatomical, physiological, biochemical, genetic, and even molecular responses of plants to hypoxic stresses and anoxia (see, for example, Kennedy et al., “Anaerobic metabolism in plants,” Plant Physiol., 100:1-6 (1992); Perata, P. and A. Alphi, “Plant responses to anaerobiosis,” Plant Sci., 93:1-17 (1993); Richard et al., “Plant metabolism under hypoxia and anoxia,” Plant Physiol Biochem., 32:1-10 (1994); and Vartapetian, B. and M. Jackson, “Plant adaptations to anaerobic stress,” Ann Bot. (London), 79(suppl. A):3-20 (1997)). In the absence of oxygen, plants cannot perform critical life sustaining functions such as nutrient and water uptake and normal root development. On a cellular level, injury to plants due to hypoxic stresses has been attributed to the accumulation of toxic end products of anaerobic metabolism, to the lowering of energy (ATP) metabolism, or to a lack of substrates for plant respiration. With plant seeds, oxygen bioavailability is particularly important because it improves seed metabolism, seed ability to grow, and seed vigor to inclement environments.

Winter ice encasement, seed imbibition, spring floods, waterlogged farmlands, wetlands, hydric soil, and excessive rainfall are all examples of natural conditions leading to root hypoxia or anoxia. Flooding of soil can lead to acute oxygen deprivation of plant roots because the transfer of oxygen and other gases is blocked when pores in the soil become filled with water. Even in artificial and controlled conditions, such as with hydroponic systems, plants have exhibited signs of root hypoxia.

Current attempts to address hypoxic stresses have not been successful. For example, in order to minimize loss of crop yield and economy resulting from hypoxic stresses, biologists and agricultural scientists have attempted to develop crop cultivars with enhanced, genetically-engineered defenses against hypoxic stresses. Unfortunately, genetic engineering and molecular technologies for improving flood tolerance of crops are still in progress and are not expected to alleviate the hypoxia/anoxia problem anytime in the near future.

Another attempt to resolve hypoxic stresses involves agriculture cultivation planning/measures. For instance, implementation of agronomic drainage measures is helpful in enhancing performance in waterlogged farmlands and wetlands. This measure, however, is not effective when flooding and/or other unexpected natural conditions leading to hypoxic stresses occur.

Thus, oxygen is something that is essential to plants as well as all other organisms. About 21% of air is composed of gaseous oxygen; however, air-saturated water has only about 250 μM oxygen. Furthermore, the diffusion coefficient of gaseous oxygen in air is 0.214 cm²/s whereas the diffusion coefficient of gaseous oxygen in water is only 0.0000197 cm²/s. Thus, bioavailable gaseous oxygen is not readily available to plants under hypoxic conditions. Unfortunately, gaseous oxygen is not easily transferred or manipulated in flooded or waterlogged conditions; nor is it practical or economical to continuously deliver gaseous oxygen to agricultural fields. Oxygen in liquid phase is not readily available nor is it feasible for delivery to plants because of its temperature (−183° C.).

Insofar as is known, a buffer system for providing oxygen has not been previously reported as being useful for the treatment of hypoxia and/or anoxia in soil-grown or hydroponic-cultivated plants when subjected to hypoxic stresses (such as flooding).

### BRIEF SUMMARY OF THE INVENTION

The subject invention provides systems and methods for improving oxygen supply to plants when subjected to hypoxic stresses. According to the invention, compositions comprising an oxygen source are added to soil or aqueous solutions in which plants are grown, wherein the amount of composition added to the soil or aqueous solution is effective in providing bioavailable oxygen to promote plant survival and growth. The compositions of the invention can be provided in either a solid or liquid form.

In one embodiment, the compositions of the invention comprise an oxidizing agent, wherein bioavailable oxygen is released from the composition when contacted with water in soil. In a preferred embodiment, the oxidizing agent is a peroxide, which can be either sparsely or highly soluble. Examples of peroxides for use in accordance with the invention include, but are not limited to, hydrogen peroxide, magnesium peroxide, peracetic acid, sodium peroxide, sodium percarbonate, potassium peroxide, calcium peroxide, carbamide peroxide, and potassium peroxide.

According to the subject invention, the level and rate of oxygen released from the compositions of the invention can be controlled. Control over the release of bioavailable oxygen from the compositions of the invention depends on the solubility of the oxidizing agent. For example, each of sparsely soluble peroxides has its own unique solubility index, which can be controlled by manipulating the ion charge. Methods for manipulating ion charge include, but are not limited to, adding companion cations (such as those in the insoluble peroxides); adding a cation reducing agent (such as a chelator); and adjusting pH. Using such methods, the compositions of the invention can be applied to soils or hydroponic aqueous solutions to enable release of bioavailable oxygen to plant roots on a continuous, controlled basis.

In a preferred embodiment, the subject invention provides a fertilizer composition comprising an oxidizing agent. The fertilizer is preferably one that can be applied to seeds (such as in the form of an exterior film or coating), wherein the fertilizer provides controlled release of bioavailable oxygen to the seedlings during growth. The oxygen fertilizer can be used for agronomic crops in low elevation agricultural lands, for native vegetation restoration in protected areas such as the Everglades, and to improve water quality by increasing aerobic activity in contaminated water bodies.

The subject invention relates not only to the treatment of soil or hydroponic aqueous solutions during or after plant subjection to a hypoxic stress, but includes pretreatment of soil or aqueous solutions as well.

According to the subject invention, a composition is provided that can be manufactured using currently available oxidizing agent production facilities, wherein the composition contains highly concentrated amounts of the oxidizing agent.

Preferably, the subject invention provides a safe, cost-effective, and easily monitored process for improving oxygen supply to plants in any growth medium. More preferably, the subject invention provides various methods and formulations for the manufacture of a composition containing an oxidizing agent, wherein controlled release of bioavailable oxygen is provided by the composition in any growth medium.

Finally, the compositions and methods of the invention can be used to resolve oxygen supply to seedlings, plantlings, potted plants, agriculture crops, horticulture plants, forestry, soilless culture plants, or even pisciculture plants.

### BRIEF DESCRIPTION OF THE FIGURES

FIG. 1 is a graphical illustration of corn seed germination rates when subjected to different bioavailabilities of oxygen.

FIG. 2 is a graphical illustration of germination rates of old (3 years old) and new corn seeds when subjected to different bioavailabilities of oxygen.

FIG. 3 is a pictorial illustration of the effect of oxygen on germination rates of corn seeds.

FIG. 4 is a graphical illustration of ADH activities of corn embryos when subjected to different bioavailabilities of oxygen.

FIG. 5 is a graphical illustration of proton flux from corn seed embryos or endosperms when treated in accordance with one embodiment of the invention.

FIG. 6 is a graphical illustration of oxygen consumption rate by corn seeds soaked in water with and without treatment in accordance with one embodiment of the invention.

FIG. 7 is a graphical illustration of imbibition rates of corn seeds treated with one embodiment of the invention.

FIG. 8 is a graphical illustration of imbibition kinetics of corn seeds when subjected to one embodiment of the invention.

FIG. 9 is a graphical illustration of oxygen release from different sources.

FIG. 10 is a graphical illustration of the effect of EDTA in liberating bioavailable oxygen from one embodiment of the invention.

FIG. 11 is a graphical illustration of the effect of companion cation Mg²⁺ in liberating bioavailable oxygen from one embodiment of the invention.

FIG. 12 is a graphical illustration of the depletion of oxygen by one corn plant grown with a composition that excludes an oxidizing agent.

FIG. 13 is a graphical illustration of the depletion of oxygen by one corn plant grown with a composition of one embodiment of the invention.

FIG. 14 is a graphical illustration of the depletion of oxygen by one corn plant grown with one composition of another embodiment the invention.

FIG. 15 is a graphical illustration of the depletion of oxygen by one corn plant grown with a composition of another embodiment of the invention.

FIGS. 16a and 16b are graphical illustrations of the depletion of oxygen by one corn plant grown with a composition of another embodiment of the invention.

FIG. 17 is a graphical illustration of oxygen released from compositions of various embodiments of the invention.

FIG. 18 is a graphical illustration of oxygen released from compositions of various embodiments of the invention.

FIGS. 19a and 19b are graphical illustrations of changes in oxygen level from different solutions of various embodiments of the invention.

FIGS. 20 through 22 are illustrations of various corn plants grown using compositions of the invention.

FIG. 23 is a graphical illustration of ADH levels when subjected to various levels of bioavailable oxygen.

FIG. 24 is a graphical illustration of ADH activity of corn seedlings when subjected to various hypoxic conditions.

FIG. 25 is a graphical illustration of NR activity of corn seedlings when subjected to various hypoxic conditions.

FIG. 26 is a graphical illustration of ADH activity of corn seedlings when subjected to various hypoxic conditions in the presence or absence of hydrogen peroxide.

FIG. 27 is a graphical illustration of NR activity of corn seedlings when subjected to various hypoxic conditions in the presence or absence of hydrogen peroxide.

FIG. 28 is a graphical illustration of the effect of compositions of the invention on ADH activity on corn seedlings when subjected to various hypoxic conditions.

FIG. 29 is a graphical illustration of the amount of protons extruded from corn root under anoxic conditions.

FIG. 30 is a graphical illustration of the amount of protons extruded from corn root under hypoxic conditions.

FIG. 31 is a graphical illustration of the amount of protons extruded from corn root under normal conditions.

FIG. 32 is a depiction of the effect of various compositions of the invention on plant growth when subjected to flooded conditions.

FIG. 33 is a graph showing the effect of a composition of the invention on sodium content reduction in leaves.

FIG. 34 is a graph showing the effect of a composition of the invention on biomass increase.

### DETAILED DESCRIPTION OF THE INVENTION

The present invention provides compositions and methods for addressing hypoxic stresses, wherein the invention resolves bioavailable oxygen supply to plants in any growth medium (such as soil, aqueous hydroponic solutions, and the like). The compositions of the invention preferably comprise an oxidizing agent, which serves as the source of oxygen to address hypoxic stress.

The compositions of the present invention are particularly useful not only in addressing hypoxic stress but also in stimulating plant growth, enhancing plant vigor, and/or improving crop yield.

In operation, the compositions of the invention are applied to the plant, seed, or plant growth medium either before, during, or after the plant experiences hypoxic stress. Plant growth media include soils and aqueous hydroponic solutions, for example. Methods according to the invention involve the application of liquid and/or dry formulations of the compositions of the invention. Preferably, the compositions of the invention are applied to the seed or the plant growth medium.

Optionally, one or more of the following ingredients can be added to an oxidizing agent in the preparation of compositions of the invention: companion cations; cation reducing agents; pH modulating compounds; plant nutrients; organic compounds; macronutrients; micronutrients; penetrants; beneficial microorganisms; soil or plant additives; pesticides; fungicides; insecticides; nematocides; herbicides; growth materials; and the like.

Oxidizing agents useful in the practice of the subject include, but are not limited to, peroxides, superoxides, nitrates, nitrites, perchlorates, chlorates, chlorites, hypochlorites, dichtromates, permanganates, and persulfates. Non-limiting examples of oxidizing agents include: hydrogen peroxide, magnesium peroxide, peracetic acid, sodium peroxide, sodium percarbonate, potassium peroxide, calcium peroxide, potassium oxide, aluminum nitrate, potassium dichromate, ammonium persulfate, potassium nitrate, barium chlorate, potassium persulfate, barium nitrate, silver nitrate, barium peroxide, sodium carbonate peroxide, calcium chlorate, sodium dichloro-s-triazinetrione, calcium nitrate, sodium dichromate, sodium nitrate, cupric nitrate, sodium nitrite, sodium perborate, lead nitrate, sodium perborate tetrahydrate, lithium hypochlorite, sodium perchlorate monohydrate, lithium peroxide, sodium persulfate, magnesium nitrate, strontium chlorate, magnesium perchlorate, strontium nitrate, strontium peroxide, nickel nitrate, zinc chlorate, nitric acid, zinc peroxide, perchloric acid, calcium hypochlorite, potassium permanganate, chromium trioxide (chromic acid), sodium chlorite, halane, sodium permanganate, trichloro-s-triazinetrione, ammonium dichromate, potassium chlorate, potassium dichloroisocyanurate, sodium chlorate, potassium bromate, sodium dichloro-s-triainetrione, ammonium perchlorate, ammonium permanganate, guanidine nitrate, potassium superoxide, carbamide peroxide, and ozone.

Preferably, the compositions of the invention comprise insoluble or soluble peroxides. Preferred peroxides for use in accordance with the subject invention include: hydrogen peroxide, magnesium peroxide, calcium peroxide, sodium percarbonate, carbamide peroxide, and sodium peroxide. More preferably, the compositions of the invention comprise magnesium peroxide and/or calcium peroxide. Preferably, the peroxide of the invention is of 50% purity. More preferably, the peroxide of the invention is of 55%, 60%, 70%, 75%, 80%, 85%, 90%, 95%, or 99% purity so that the level and rate of oxygen release can be easily manipulated in accordance with the methods disclosed in the subject invention.

In certain embodiments, the compositions of the invention combine an oxidizing agent with other compounds useful in controlling the level and rate of release of oxygen. Examples of compounds useful in the control of oxygen released from compositions of the invention include, but are not limited to, companion cations (such as those having redox potential); cation reducing agents (such as a chelator); and pH modulating compounds.

In one embodiment, the compositions of the invention comprise an oxidizing agent in combination with a companion cation to manipulate ion charge and, hence, the level and rate of bioavailable oxygen release from the composition. Examples of companion cations (that participate as an electron donor in the reduction of the oxidizing agent to release bioavailable oxygen) include, but are not limited to, Mg²⁺, Mn²⁺, Ca²⁺, Cu²⁺, Zn²⁺, and the like.

In another embodiment, the compositions of the invention comprise an oxidizing agent in combination with companion cation and/or a cation reducing agent to manipulate ion charge and, hence, the level and rate of bioavailable oxygen release from the composition. Examples of cation reducing agents (that donates electrons to a companion cation that has participated in the generation of oxygen from the oxidizing agent) include, but are not limited to, chelators such as water, carbohydrates (including polysaccharides), organic acids with more than one coordination group, lipids, steroids, amino acids and related compounds, peptides, phosphates, nucleotides, tetrapyrrols, ferrioxamines, ionophores (such as gramicidin, monensin, valinomycin), phenolics, 2,2′-bipyridyl, dimercaptopropanol, Ehtylenediaminotetraacetic acid (EDTA), Ethylene glycol-bis-(2-aminoethyl)-N,N,N′ (EGTA), Nitrilotracetic acid (NTA), salicylic acid, and triethanolamine (TEA).

In one embodiment, the compositions of the invention comprise an oxidizing agent in combination with various pH modulating compounds to manipulate the ion charge of the composition and, hence, control the level and rate of bioavailable oxygen released from the composition. According to the subject invention, pH modulating compounds that can be used to manipulate ion charge include, but are not limited to, ammonia compounds, nitrate compounds, ammonium phosphate compounds, ammonium nitrate compounds, phosphate compounds, and biological buffers such as ACES buffers, N-(2-hydroxyethyl)-piperazine-N′-2-ethanesulfonic acid (HEPES buffer), triethanolamine (TEA), MES buffer, ADA buffer, 2-amino-2-methyl-1-propanol (AMP), 2-amino-2-methyl-1,3-propanediol (AMPD) and the like.

In related embodiments, the compositions of the invention can include plant nutrients, organic compounds, macronutrients, micronutrients, penetrants, beneficial microorganisms, soil or plant additives, pesticides, fungicides, insecticides, nematocides, herbicides, growth materials, and the like.

According to the subject invention, plant nutrients that can be added include macronutrients such as nitrogen (N), phosphorus (P), potassium (K), secondary nutrients such as calcium (Ca), magnesium (Mg), and micronutrients such as Iron (Fe), zinc (Zn), manganese (Mn), copper (Cu), and boron (B). Any combination of plant nutrients, macronutrients, secondary nutrients, and/or micronutrients can be used in the preparation of the compositions according to the subject invention.

In one embodiment, organic compounds are added to compositions of the invention. Examples of organic compounds include, but not limited to, biosolids, humic acid, fulvic acid, seaweed extracts, kelp extracts, activated sludge, municipal compost, animal manures (e.g., horse, cow, chicken, pig, sheep, etc.), and composted organic byproducts.

Microorganisms useful in the practice of the invention can be selected from one or more of bacteria, fungi, and viruses that have utility in soil enhancement. Viruses such as the NPV viruses (nuclear polyhedrosis virus) and the cabbage looper nuclear polyhedrosis virus are examples of useful viruses. Any combination of one or more microorganisms may be used in the practice of the subject invention.

Microorganisms (bacteria, fungi and viruses) that control various types of pathogens in the soil include microorganisms that control soil-born fungal pathogens, such as Trichoderma sp., Bacillus subtilis, Penicillium spp.; microorganisms that control insects, such as Bacillus sp., e.g., Bacillus popalliae; microorganisms that act as herbicides, e.g., Alternaria sp., and the like. These organisms are readily available from public depositories throughout the world.

Non-limiting examples of beneficial microorganisms that can, optionally, be added to the compositions of the invention to enhance the quality of soil for the growth of plants include: microorganisms of the genera Bacillus, for example B. thurigensis; Clostridium, such as Clostridium pasteurianum; Rhodopseudomonas, such as Rhodopseudomonas capsula; Rhizobium species that fix atmospheric nitrogen; phosphorous stabilizing Bacillus, such as Bacillus megaterium; cytokinin producing microorganisms such as Azotobacter vinelandii; Pseudomonas, such as Pseudomonas fluorescens; Athrobacter, such as Anthrobacter globii; Flavobacterium such as Flavobacterium spp.; and Saccharomyces, such as Saccharomyces cerevisiae, and the like. The number of microorganisms that can be used in the practice of the subject invention can range from about 10⁵ to 10¹⁰ organisms per gram of composition.

Optional soil and/or plant additives that can be added to the compositions of the invention include water trapping agents, such as zeolites; natural enzymes; growth hormones (such as the gibberellins, including gibberellic acid and gibberellin plant growth hormones); and control agents, including pesticides such as acaracides, molluskicides, insecticides, fungicides, nematocides, and the like.

The compositions of the invention may be applied in the form of dusting powders, wettable powders, granules (slow or fast release), emulsion or suspension concentrates, liquid solutions, emulsions, seed dressings, or controlled release formulations such as microencapsulated granules or suspensions, soil drench, irrigation component, or a foliar spray.

Dusting powders are formulated by mixing the oxidizing agent with one or more finely divided solid carriers and/or diluents, for example natural clays, kaolin, pyrophyllite, bentonite, alumina, montmorllonite, kieselguhr, chalk, daiatomaceous earths, calcium phosphates, calcium and magnesium carbonates, sulfur, lime, flours, talc and other organic and inorganic solid carriers.

Granules are formed either by absorbing the oxidizing agent in a porous granular material for example pumice, attapulgite clays, fuller's earth, kieselguhr, diatomaceous earths, ground corn cobs, and the like, or on to hard core materials such as sands, silicates, mineral carbonates, sulfates, phosphates, or the like. Agents which are commnonly used to aid in impregnation, binding or coating the solid carriers include aliphatic and aromatic petroleum solvents, alcohols, polyvinyl acetates, polyvinyl alcohols, ethers, ketones, esters, dextrins, sugars and vegetable oils, with the active ingredient. Other additives may also be included, such as emulsifying agents, wetting agents or dispersing agents.

Microencapsulated formulations (microcapsule suspensions CS) or other controlled release formulations may also be used, particularly for slow release over a period of time, and for seed treatment.

Alternatively the compositions may be in the form of liquid preparations to be used as dips, irrigation additives or sprays, which are generally aqueous dispersions or emulsions of the oxidizing agent in the presence of one or more known penetrant (such as wetting agents, dispersing agents, emulsifying agents, surface active agents). The compositions which are to be used in the form of aqueous dispersions or emulsions are generally supplied in the form of an emulsifiable concentrate (EC) or a suspension concentrate (SC) containing a high proportion of the active ingredient or ingredients. An EC is an homogeneous liquid composition, usually containing the active ingredient dissolved in a substantially non-volatile organic solvent. An SC is a fine particle size dispersion of solid active ingredient in water. To apply the concentrates they are diluted in water and are usually applied by means of a spray to the area to be treated.

Suitable liquid solvents for ECs include methyl ketone, methyl isobutyl ketone, cyclohexanone, xylenes, toluene, chlorobenzene, paraffins, kerosene, white oil, alcohols (for example, butanol), methylnaphthalene, trimethylbenzene, trichloroethylene, N-methyl-2-pyrrolidone and tetrahydrofurfuryl alcohol (THFA).

These concentrates are often required to withstand storage for prolonged periods and after such storage, to be capable of dilution with water to form aqueous preparations which remain homogeneous for a sufficient time to enable them to be applied by conventional spray equipment. The concentrates may contain 1-85% by weight of the oxidizing agent. When diluted to form aqueous preparations such preparations may contain varying amounts of the active ingredient depending upon the purpose for which they are to be used.

The composition may also be formulated as powders (dry seed treatment DS or water dispersible powder WS) or liquids (flowable concentrate FS, liquid seed treatment LS), or microcapsule suspensions CS for use in seed treatments. The formulations can be applied to the seed by standard techniques and through conventional seed treaters. In use the compositions are applied to the plants, to the locus of the plants, by any of the known means of applying fertilizer compositions, for example, by dusting, spraying, or incorporation of granules.

When the final solution is to be applied to plants which, because of their hairy or waxy surface, may be difficult to wet, it may also be advantageous to include other additives, commonly known in the agrochemical industry, such as surfactants, wetting agents, spreaders and stickers. Examples of wetting agents useful in the practice of the subject invention include silicone surfactants, nonionic surfactants such as alkyl ethoxylates, anionic surfactants such as phosphate ester salts and amphoteric or cationic surfactants such as fatty acid amido alkyl betaines.

As indicated above, the compositions produced according to the present invention are usually applied to the plants or seedlings, but may also be applied to the soil or added to the irrigation water or other aqueous growth solution. The compositions of the invention may be used advantageously on many types of agricultural and horticultural crops, including but not limited to, cereals, legumes, brassicas, cucurbits, root vegetables, sugar beet, grapes, citrus and other fruit trees and soft fruits. More particularly, crops that will benefit from the compositions include, but are not limited to, corn, peas, oil seed rape, carrots, spring barley, avocado, citrus, mango, coffee, deciduous tree crops, grapes, strawberries and other berry crops, soybean, broad beans and other commercial beans, tomato, cucurbitis and other cucumis species, lettuce, potato, sugar beets, peppers, sugar cane, hops, tobacco, pineapple, coconut palm and other commercial and ornamental palms, rubber and other ornamental plants.

Following are examples which illustrate procedures for practicing the invention. These examples should not be construed as limiting. All percentages are by weight and all solvent mixture proportions are by volume unless otherwise noted.

### EXAMPLE 1

### Materials and Methods

Corn seeds of FR27 x FRM017 (GRADE: 24RD) were provided by Illinois Foundation Seeds Inc. Two sets of seeds were used: one set of seeds consisted of fresh seeds and the other set of seeds consisted of seeds that were two-years old.

Chemicals used in the Example included: N, N-Dimettyltrimethylslylamine (cat no. 41716, Fluke Chemika, Switzerland), hydrogen ionophore I—Cocktail B (cat no. 95293, Fluke Chemika, Switzerland), 3% H2O2, Cumberland Swan Smyrna, USA. Other conventional chemicals used in the Example were provided by Fluke Chemika, Switzerland.

### Germination Rates

Aeroponics: 25 liters of pure water were poured into a big square tank. A 5 mm thick plastic sheet was used to cover the tank. The plastic sheet included 65 holes with 48 mm diameters that were evenly distributed throughout the sheet. Plastic baskets with sides that were 50 mm high and having external diameters of 55 mm at the top and 37 mm at the bottom were situated in each hole. Six seeds were put in each basket.

On the tank bottom, a 24-Watt-electric pump (made by Danner Mfg. Inc. USA) was installed to pump water to the seeds through the baskets. The nozzle of the pump was stabilized in the center, over the water surface. The tank was put into a growth chamber (Percival Scientific, Inc. USA), which maintained a temperature of 25° C. for 16 hours (daytime), then a temperature of 22° C. for 8 hours (nighttime) for three days. The number of germinated seeds was counted after 48 hours.

Traditional method: 30 corn seeds and 50 ml water with 0.5 mM Ca (as CaSO₄) were placed in a 9 cm dish. The seeds soaked in the solution for 24 hours and then removed and placed on and covered by wet napkins. There were two sub treatments: embryos (in the seed) that were facing up (exposed to air) and embryos (in the seed) that were facing down (in the bottom of the dish). The number of germinated seeds was counted after 48 hours.

H₂O₂ methods: 30 seeds and 50 ml 0.5 mM Ca (as CaSO₄) with 3/5000, 3/4000, 3/3000, 3/2000, 3/1000 or 3/100 H₂O₂, separately, were placed into 9 cm dishes. The seeds were soaked in these solutions for 24 hours and then put on and covered by wet napkins. The napkins were wetted in the soaking solutions, respectively.

Aerating methods: 30 seeds were put into a plastic basket with 50 mm high sides and having external diameters of 55 mm at the top and 37 mm at the bottom. The basket was then placed on the top of a cup containing 300 ml 0.5 mM Ca. The solution was aerated for 24 hours. After that, the seeds were scattered on a wet napkin in a 9 cm dish and covered by a wet napkin as well. The napkins were wetted in the solution from the cup. The number of germinated seeds was counted after 48 hours.

### Imbibition Measurement

Ten corn seeds were placed in a vial with 20 ml soaking solution containing 0.5 mM CaSO4 without (control) or with 3/2000 H₂O₂ (treatment) at 30° C. as a single repetition. The seeds were weighed before placement into the vials as well as every 24 hours after complete drying with napkins.

### Microelectrode Fabrication

1.5 mm borosilicate glass capillaries (cat no. TW150-4) that were 10 cm in length were pulled into two micropipettes through a Sutter P-97 at 545° C. The freshly pulled micropipettes were silanized at 200° C. with N,N-Dimethyltrimethylslylamine according to Smith's method (Smith, P J S et al., “Self-referencing, non-invasive, ion selective electrode for single cell direction of trans-plasma membrane,” Microscopy Research and Technique, 46:398-417 (1999)).

Micropipettes were backfilled with H⁺ probe backfilling solution of 50 mM KCl and 50 mM HK₂PO₄. Then hydrogen ionophore I—Cocktail B (cat no. 95293, Fluke Chemika, Switzerland) was drawn into the tip with a minimal negative pressure under a binocular compound microscope as described by Smith et al. (“Self-referencing, non-invasive, ion selective electrode for single cell direction of trans-plasma membrane,” Microscopy Research and Technique, 46:398-417 (1999)).

### Measurements of Net Ion Fluxes

45 g of Sylgard 184 silicone elastomer and 5 g of Sylgard 184 curing agent (Dow Corporation, USA) were poured into the bottom of a 10 cm Pyrex dish in order to provide a medium for stabilizing the tested treated seeds. One seed was appropriately stabilized in the center of the Pyrex dish with 4 to 5 stainless-steel needles.

Microelectrodes were calibrated before and after each experiment. Calibrations were performed at standard pH 6, 7, and 8 solutions (Fisher Scientific) at 25° C. The Nernst Slopes (in mV decade⁻¹) were equal or close to 59. Following calibration, the microelectrode was positioned on both the embryos and endosperm of the targeted seed. Then, the embryo and endosperm were, respectively, scanned 100 μm by 100 μm. At least 10 scans were done on either embryo or endosperm.

### Measurements of Oxygen Consumption

The tested seeds were stabilized as described above. The seed samples were soaked in 0.5 mM CaSO₄ solution with or without 3/2000 hydrogen peroxide for one day before any measurements were made. Pt/Ir oxygen electrodes were used. The microelectrodes were calibrated before and after each experiment. Calibrations were performed in deionized water saturated with air (which includes 21% oxygen concentration) and then bubbled with nitrogen gas for at least 30 min (so as to provide 0% oxygen concentration). Ten scans were done on either embryos or endosperms.

### ADH Activity

Alcohol dehydrogenase (“ADH”) activities of corn embryos placed in environments with different concentrations of bioavailable oxygen at 48 hours after germination at 25° C. were observed. Before germination, corn seeds were soaked in 0.5 mM CaSO₄ solution, in aeroponics, or in 3/2000 H₂O₂ for 24 hours. All of the embryos were exposed to air except for one sample group treated with water, which was placed into soil.

Following treatment, each corn seed was cut into two halves on the embryo. Four halves of embryos were homogenized in extraction buffer including 50 mM Tris-HCl (pH 8.0), 1 mM EDTA, 0.5 mg/ml DTT, and 12 μM mercaptoethanol. The suspension solution of the enzyme was centrifuged twice at 15000 rpm for 5 min in order to separate oil (on the top) from pellets (at the bottom). The supernatant from the second centrifuge was used to measure ADH activity.

ADH activity assay was performed according to the procedures described by Xie and Wu (Xie Y. and R. Wu, “Rice alcohol dehydrogenase genes: anaerobic induction, organ specific expression and characterization of cDNA clones,” Plant Mol. Biol., 13:53-68 (1989)). 100 μl of the enzyme solution and 900 μl of reaction solution that included 50 mM Tris-HCl (pH 9.0), 1 mM EDTA, and 1 mM NAD were incubated in 1.5 ml Eppendorf tubes in a water bath at 30° C. for 3 min. Then, 100 μl 15% ethanol and the reaction solution were added directly to cuvette. Reaction time was 1 min. in the cuvette at 340 nm. The assay uses ethanol as the substrate and measures the production of NADH. Measurement of NADH formation was performed in a spectrophotometer (DU 64, Beckman Instruments, Fullerton, Calif.). A unit of ADH is defined as the production of 1 nmol NADH min⁻¹ mg⁻¹ protein. The relative ADH activity was calculated based on taking the ADH activity of corn seeds germinated in aeroponics as 100%.

### Protein Measurement

Protein contents of the samples were calorimetrically determined according to Lowry's method (Lowry O H et al., “Protein measurement with the Folin phenol reagent,” J Biol Chem 193:265-275 (1951); Peterson G, “A simplification of the protein assay method of Lowry et al., which is more generally applicable,” Analytical Biochem. 83:346-356 (1977)). 10 μl of supernatant was mixed with 990 μl Lowry A: equal volumes of copper-tartrate-carbanate (CTC) solution consisting of 0.1% CuSO₄.5H₂O, 0.2% KNa-tartrate and 10% NaCO)₃; 10% sodium dodecyl sulfate (95% SDS, sigma # L-5750); 0.80 N NaOH; and deionized water. 15 min later, 500 μl Lowry B (one part of 2.0 N Folin & Ciocalteu's Phenol Reagent Solution (Sigma # F-9252) that was diluted in 5 parts of deionized water) was added. Bovine Serum Albumin (BSA, Sigma # A-2153) was used to prepare the standards.

All of the corn embryos were faced up to air unless specified to face down in solution. The measurements were all performed in triplicate.

### Effects of Oxygen Bioavailability on Corn Germination Rates

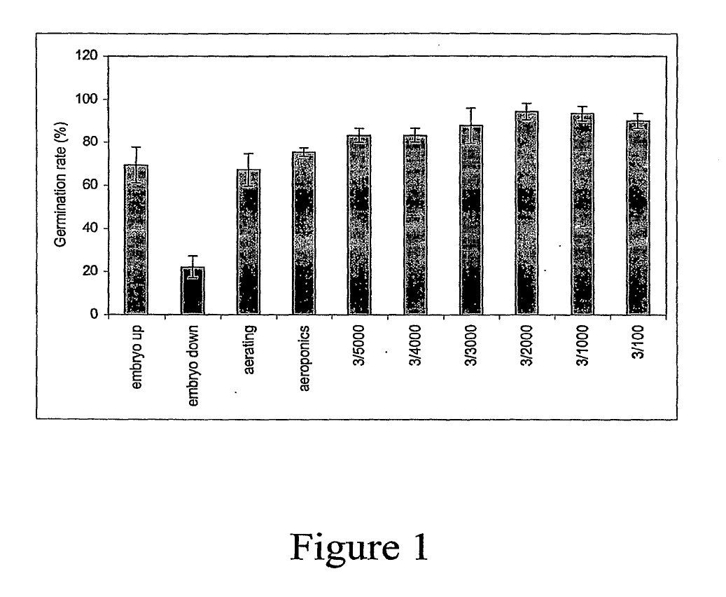

FIG. 1 is a graphical depiction of germination rates of corn seeds under different bioavailabilities of oxygen at 48 hours after germination. All of the embryos of the seeds were up to air unless specialized. The fractions are levels of hydrogen peroxide. FIG. 1 shows that exposure of seeds to hydrogen peroxide (H₂O₂) provides significantly better germination rates than non-hydrogen peroxide exposure. This indicates that bioavailable oxygen is necessary for proper seed germination. As shown in FIG. 1, among the treatments with varying concentrations of H₂O₂, those seeds exposed to 3/2000 H₂O₂ exhibited the best germination rates. This suggested that too much bioavailable oxygen may hinder seed germination.

In fact, seeds exposed to 3/100 hydrogen peroxide exhibited limited growth of roots. Those seed exposed to 3/100 H₂O₂ had very stunted roots, with root lengths of 6.8±1.7 mm. However, those seeds exposed to 3/2000 H₂O₂ had root lengths of 34.8±1.7 mm and even those seeds that were not exposed to H₂O₂ had root lengths of 30±10.8 mm at the third day after germination.

These results proved that sufficient bioavailable oxygen was good not only for seed germination but also for root growth. Nevertheless, it appeared that too much bioavailable oxygen lowered the germination rate and also damaged the roots of the new germinated seedlings because of the high oxidation potential.

All kinds of seeds experience ageing and their life activities function poorly after one year. Hence, germination rates for seeds that are older than one year (under storage at room temperature) are mediocre at best. That is why it is encouraged that new seeds be sown for crop productions.

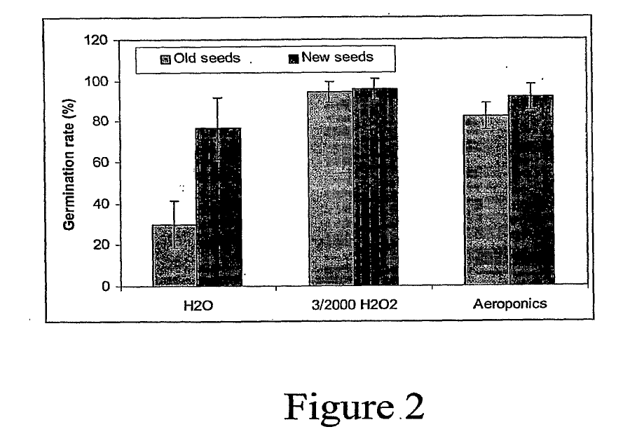

FIG. 2 illustrates the germination rates of old (3 years old) and new corn seeds under different treatments: with 3/2000 H₂O₂, which provides the most bioavailable oxygen; with aeroponics, which provides somewhat less bioavailable oxygen; and with water, which provides the least amount of bioavailable oxygen. The germination rates for both of old and new seeds were very consistent with the amount of oxygen available for each treatment.

FIG. 2 shows that the more sufficient the oxygen bioavailability, the less the differences in germination rates between the both kinds of seeds. Even though the germination rate of the old seeds were always lower than that of the new seeds under 3/2000 H₂O₂, the rates of both the old and new seeds were almost the same (95.6% for new seeds and 94.4% for old seeds, respectively). Similarly, the old and new seeds treated with aeroponics differed only by 9.5% (82.2% for old seeds and 91.7% for new seeds, respectively). However, those seeds with the least bioavailable oxygen (treatment with water) had germination rates that varied by more than 2.5 times (30.0% for old seeds and 76.7% for new seeds). This suggested that the aged seeds were much more sensitive to oxygen bioavailability than the new seeds. This also implied that supply of appropriate bioavailabilities of oxygen may be a method for rescuing aged seeds that may need to be used sometimes for crop production.

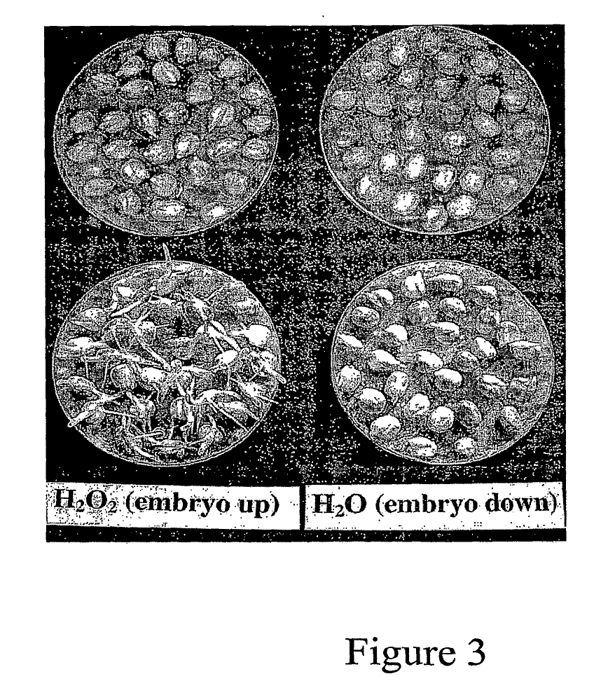

FIG. 3 shows the effects of bioavailability of oxygen on germination rates of corn seeds. The top pair germinated for one day. The bottom pair for three days. FIG. 3 shows that all of the seeds were able to germinate at 24 hours if there was sufficient oxygen, such as via 3/2000 H₂O₂, but almost nothing happens to those seeds without hydrogen peroxide. Those seeds with sufficient oxygen had both shoots and roots with 1 to 2 cm in length after 72 hours; but in those seeds without exposure to H₂O₂, only one third of the seeds germinated by that time. This proved that corn seeds in water were undergoing hypoxic stress and hence their germination rate was low. Accordingly, supply of sufficient bioavailable oxygen is an effective way to improve the germination rates of corn seeds for crop production.

### ADH Activities of Corn Embryos

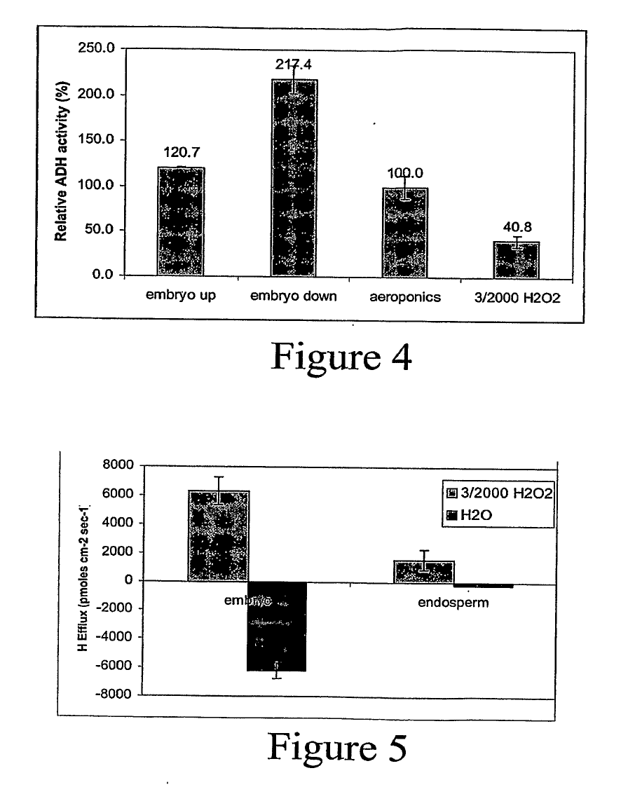

It is well known that ADH is an adaptable protein produced by plants under hypoxic stress. FIG. 4 illustrates the ADH Activities of corn embryos in different oxygen bioavailability at 48 hours after germination at 25° C. Before germination, corn seeds were soaked in water, in aeroponics or in 3/2000 H₂O₂ for 24 hours. All the embryos were put up to air but those of one treatment with water were put down to ground. FIG. 4 shows that orientation of corn seed embryos mattered much with ADH activities. When embryos faced “down” to the bottom of the container, their ADH activities were almost doubled compared with those facing up to the air (such as those seeds that were placed in suspended in mist and with plenty of air—aeroponics). As seen in FIG. 4, exposure to hydrogen peroxide with a concentration of 3/2000 caused those seeds with embryos facing downward to exhibit diminished ADH activity (by about 40%), almost to that of the level of aeroponics-treated seeds.

At 25° C., the dissolved oxygen level in the aeroponics medium is only about 250 μM. This little amount of dissolved oxygen might be consumed only by the outer cell layers of the seeds. This means that the embryos of corn seeds that are relatively bigger in size are subject to hypoxic stress even in aeroponic environments. However, the concentration of 3/2000 hydrogen peroxide could supply about 80 times more bioavailable oxygen than aeroponics. This amount of oxygen provides sufficient oxygen not only for the outer cells but also reach the deeper-layer cells of the corn embryos. Thus, the seeds did not suffer from low-oxygen stress.

### Influx and Efflux of Protons on Corn Embryos

Proton flux is a characteristic of metabolism in living organisms. FIG. 5 shows proton efflux from corn seed embryos or endosperms treated with or without 3/2000 hydrogen peroxide for one day. FIG. 5 shows that oxygen bioavailability affects the directions of proton fluxes. Under hypoxia, both embryos and endosperms imbibed protons and, hence, exhibited a net decrease of protons on the seeds when measured in a medium of 100 μM CaCl₂. However, proton efflux occurs heavily when 3/2000 hydrogen peroxide is supplied. FIG. 5 also shows that the metabolic strength of embryos is much stronger than that of endosperms when supplied with (or even without) 3/2000 hydrogen peroxide because embryos are the center of metabolism.

### Consumption of Oxygen by Corn Seeds

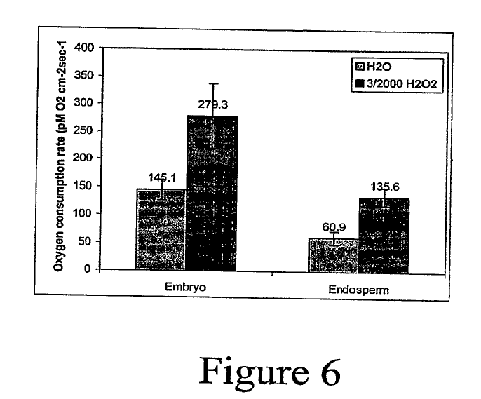

FIG. 6 shows oxygen consumption rates by corn seeds soaked in water with or without 3/2000 hydrogen peroxide for one day. FIG. 6 shows that the oxygen consumption rate of corn seeds treated with hydrogen peroxide for one day is as fast as about two times of that without hydrogen peroxide in either of embryos or endosperm. Also, embryos consumed more oxygen in either case with or without hydrogen peroxide. Clearly, the seeds were suffering from hypoxia when no hydrogen peroxide was supplied. The oxygen consumption rate for the embryos without treatment with hydrogen peroxide was about 10 pM oxygen per squared centimeter per second faster than that of the endosperm treated with hydrogen peroxide.

### Rate of Imbibition by Corn Seeds

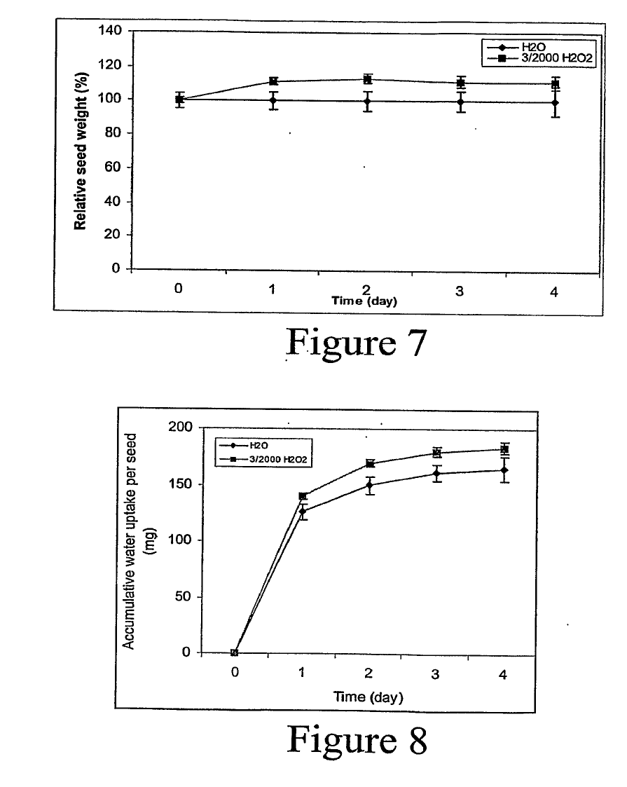

Temperature, moisture, and oxygen are the basic conditions for germination of any sort of seeds. That temperature impacts water uptake is well known. However, FIGS. 7 and 8 prove that oxygen bioavailability influences the imbibition rate of corn seeds. FIG. 7 shows the differences of imbibition rates of corn seed with or without 3/2000 hydrogen peroxide. From the first day of the experiment and onward, the imbibition rate of seeds treated with hydrogen peroxide was 11% to 13% faster than that of those without treatment of hydrogen peroxide. FIG. 8 shows kinetics of imbibition by corn seeds with or without 3/2000 hydrogen peroxide. These kinetics of imbibition indicate that accumulative water uptake with hydrogen peroxide is 14 to 20 points of percentage faster than without hydrogen peroxide. This indicates that bioavailability of oxygen improves water uptake by seeds.

### EXAMPLE 2

### Materials

Corn seeds, FR27 x FRMO17, were provided from Illinois Foundation Seeds, Inc. All the chemicals were from Sigma-Aldrich except the compositions comprising oxidizing agents. Solid compositions comprising oxidizing agents include: sodium percarbonate, calcium peroxide and magnesium peroxide, which were provided by Solvary Interox, Inc. Liquid compositions comprising oxidizing agents include 3% hydrogen peroxide, which was provided by Wal-Mart.

### Oxygen Solution or O₂ Buffer Preparation

One hundred milligrams of each of the above solid compositions comprising oxidizing agents was put in a 50 ml polypropylene tube, respectively, unless specialized. 50 ml de-ionized water or nutrient solution was put into the tubes. The strength of the nutrient solutions was 25%, 50%, 100%, 200% or 400% of Yan's formula (Yan, F. et al., “Adaptation of active proton pumping and plasmalemma ATPase activity of corn roots to low root medium pH,” Plant Physiology, 117:311-319 (1998)). The oxygen solutions were allowed to equilibrate over night before any measurements were made.

### Culture Methods

All the seeds were germinated and grown in aeroponics in Yan's recipe (Yan, F. et al., “Adaptation of active proton pumping and plasmalemma ATPase activity of corn roots to low root medium pH,” Plant Physiology, 117:311-319 (1998)) but with Si (as sodium silicate) (Epstein E., “The anomaly of siliconin plant biology,” Proc Natl Acad Sci USA. 91:11-17 (1994)) at 26° C., 60% relative humidity and at light density of 550 μmol photon m⁻²s⁻¹ (PAR) in the growth cabinet made in Percival Scientific, Inc.

### Analysis for Kinetics of O₂ Release From Sparsely Soluble Oxygen

Analysis in small volume of solution: after one week's growth, the corn seedlings reached about three-leaf stage. A single seedling was placed into the 50 ml oxygen solution with different strengths of nutrients. The oxygen contents in the solution were measured and recorded every 5 minutes or specialized. The seedlings were illuminated by a Fiber light source (Model 180, 2000 W, Dolan-Jenner Industries, Inc.) at a light density of 210 μmol photon m⁻²s⁻¹ (PAR).

Analysis in large volume of solution: after one week's growth, the seedlings were transferred to an 1800 ml nutrient solution pots with a 200% strength nutrient solution. Two plants were grown in each pot. The plants were stabilized in Light Expanded Clay Aggregate (LECA) from BareRoots Hydroponics, USA in a basket measuring 5 cm in both diameter and height. The basket was stabilized in the middle of the cover of the pot. There were 6 treatments and the following amounts of chemicals were put into each experimental pot at the beginning: 2 ml 3% hydrogen peroxide; 2 grams of sodium percarbonate; 2 grams of calcium peroxide; 2 grams of magnesium peroxide; aerating with air pump and hypoxia without aerating or any sort of oxygen. The oxygen content was determined in the culture pots every day.

### Oxygen Analysis

Oxygen contents in the solutions were determined with an oxygen electrode and ASET system (Applicable Electronics, Inc). Calibration was made by nitrogen aerating deionized water and air equilibrated deionized water. The deionized water consists of 0% oxygen level and the air equilibrated deionized water consists of 21% oxygen content. The temperature of the deionized water was measured and recorded for every measurement. The actual oxygen content in the deionized water at a specific temperature was derived from a handbook of chemistry (David R. Lide, Handbook of Chemistry and Physics, 79^{th} Edition, 1998-1999, pp. 8-87). A regressive equation was formed based on data from calibration calculations and the handbook. All of the observed values were changed into oxygen contents in micromoles through the regressive equation.

### Adjustments of O₂ Release

Different levels of companion cations of peroxides or chelate were added to the sample solutions. For example, EDTA was added to the 50 ml tubes with peroxide solutions. The peroxide solutions were made in both deionized water and nutrient solutions. After equilibrating overnight, the oxygen contents of the adjusted solutions were analyzed.

### Flooded With Solid Compositions of the Invention

All of the corn seedlings were grown for 10 days in soil in 3.78-liter pots and then all were flooded in depth of 8 cm tap water for seven days with different treatments, except for the control samples. The following treatments were included: 10 g sodium percarbonate (85% 2Na₂CO₃.3H₂O₂, 12.7% Na₂CO₃ and 1.4% Na₂SiO₃), 10 g calcium peroxide (75% CaO₂, 25% Ca(OH)₂ and CaCO₃ or 20 g magnesium peroxide (35% MgO₂, 60% MgO and 5% Mg(OH)₂) were added and mixed with the soil before setting up the experiment.

### ADH Activity

An enzyme assay was performed according to the procedures described in Chung and Ferl (“Arabidopsis Alcohol Dehydrogenase Expression in Both Shoots and Roots Is Conditioned by Root Growth Environment,” Plant Physiol, 121:429-436 (1999)) and modified slightly. ADH and nitrate reductase (“NR”) were extracted in the same extraction buffer including 50 mM Tris-HCl (pH 8.0), 1 mM EDTA, 12 μM mercaptoethanol, and 0.05 mg DTT/ml. Frozen root tissues were ground rapidly in a chilled mortar and pestle with the above chilled extraction buffer. The homogenate was centrifuged at 15 000 g at 4° C. for 15 min. 100 μl supernatant was added to 800 μl reaction solution containing 50 mM Tris-HCl buffer at pH 9.0, 1 mM EDTA and 1 mM NAD. The assay uses 15% (v/v) ethanol as the substrate and measures the production of NADH. Measurement of NADH formation was performed in a spectrophotometer (DU 64, Beckman Instruments, Fullerton, Calif.) for 69 seconds at 340 nm. A unit of ADH is defined as the production of 1 nmol of NADH min⁻¹ mg⁻¹ protein.

### Protein Measurements Assay

Protein contents of the samples were calorimetrically determined according to Lowry's method (Lowry O H et al., “Protein measurement with the Folin phenol reagent,” J Biol Chem 193:265-275 (1951); Peterson G, “A simplification of the protein assay method of Lowry et al., which is more generally applicable,” Analytical Biochem. 83:346-356 (1977)). 10 μl of supernatant was mixed with 990 μl Lowry A: equal volumes of copper-tartrate-carbonate (CTC) solution consisting of 0.1% CuSO₄.5H₂O, 0.2% Kna-tartrate and 10% NaCO₃; 10% sodium dodecyl sulfate (95% SDS, sigma # L-5750); 0.80 N NaOH and deionized water and 15 min later, 500 μl Lowry B (one part of 2.0 N Folin & Ciocalteu's Phenol Reagent Solution (Sigma # F-9252) was diluted in 5 parts of deionized water) was added. Bovine Serum Albumin (BSA, Sigma # A-2153) was used to prepare the standards.

All measurements were performed in triplicate.

### Results and Analysis: Differences of Oxygen Liberation From Various Oxygen Sources and Its Adjustments

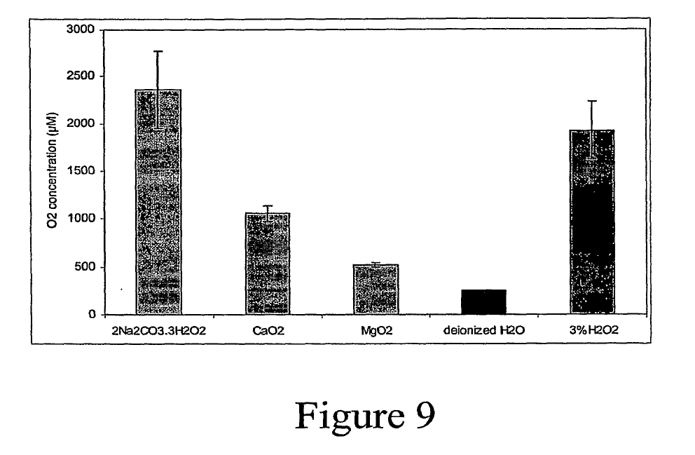

When 500 mg solid compositions comprising an oxidizing agent were placed into 50 ml deionized water, the amount of liberated oxygen depended on the solubility of the solid composition. FIG. 9 shows oxygen release from different sources. Soluble solid compositions released much more oxygen into the water than insoluble solid compositions, calcium peroxide or magnesium peroxide. Similarly, calcium peroxide released more oxygen than magnesium peroxide because the Kₛₚ of the former is about 3000 times higher than that of the latter.

Both up- and down-adjustments of oxygen released from the solid compositions were made by adding companion cations or EDTA, which took the companion cations away from the solid compositions. Ion products (Qₛₚ) would exceed the solubility products (Kₛₚ) and hence, more precipitate formed and less oxygen was released when companion cations were put into the solution with insoluble peroxide. Similarly, EDTA chelated the companion cations from the solution with sparsely soluble peroxides and hence, its Qₛₚ was less than Kₛₚ.

Consequently, more insoluble peroxides dissolved, and therefore, more oxygen was released from the solid peroxides.

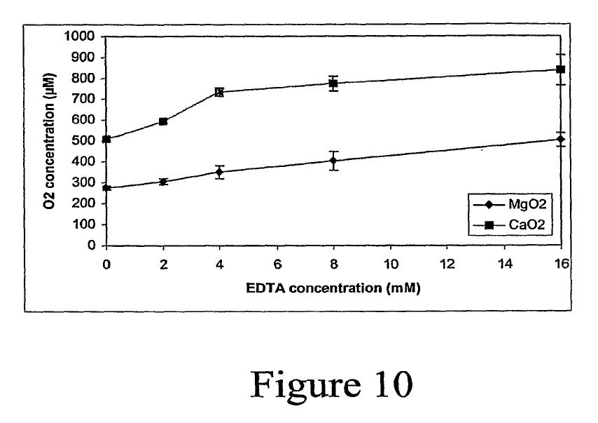

FIG. 10 shows EDTA up-adjusted oxygen liberated from the peroxides. FIG. 10 illustrates that EDTA produces more liberated oxygen because of its chelation to the cations. The two lines could be fitted by linear equations. For magnesium peroxide, the equation is y=14.185x+281.55 (r²=0.991). This indicates that each millimole of EDTA increased about 14 micromoles oxygen liberated. Likewise, for calcium peroxide, the equation is y=18.996+574.7 (r²=0.7874). This shows that every millimole of EDTA increased about 19 5 micromoles released.

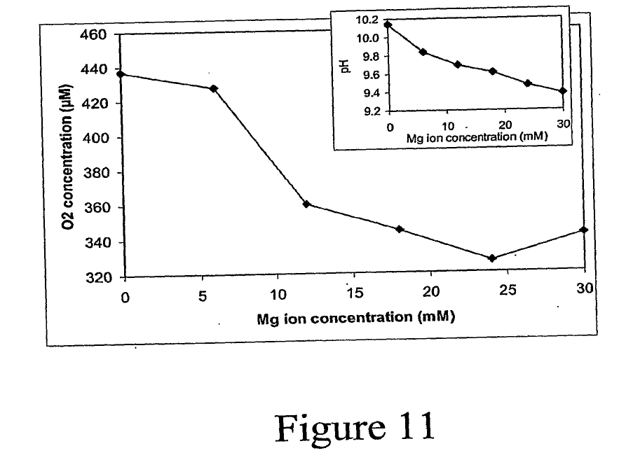

FIG. 11 shows down-adjustment of Mg²⁺ to oxygen release from magnesium peroxide. When magnesium peroxide was put in different concentrations of magnesium sulfate solution, liberated oxygen in the solutions varied significantly because extra magnesium ions inhibited solubility of the peroxide. However, magnesium was able to increase the amount of oxygen liberated; especially when its concentration reached about 25 millimoles, as shown in FIG. 11. The cation had different effects on solubility of the solid compositions of the invention: inhibition due to the effect of identical ions and acceleration because of pH effect. There was a difference of 0.7 pH units between 0 and 30 millimoles of magnesium sulfate in the solution, as illustrated by the small figure in FIG. 11. These results indicate that inhibition or acceleration of the cation to oxygen release depends on the comprehensive results of the two effects. Its acceleration effect exceeded its inhibition effect before its concentration reached 24 millimoles. But its inhibition effect overwhelmed its acceleration effect and subsequently, more oxygen was released even though it was more concentrated. This means that the companion cations were able to both up- and down-adjust the solubility of the peroxide and the cation concentration, both of which are key to directing adjustment in oxygen release.

### Buffering Ability of Different Oxygen-Controlled-Release Systems

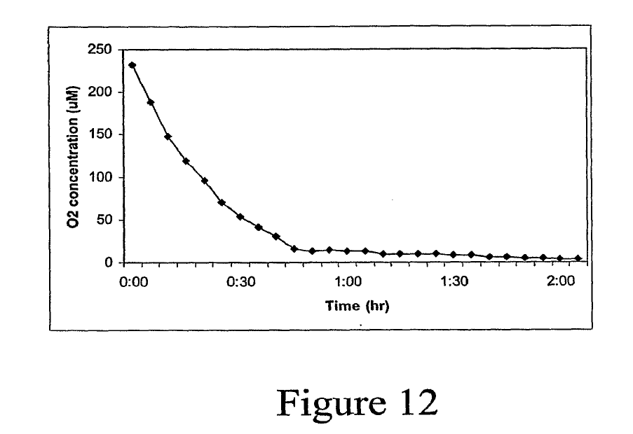

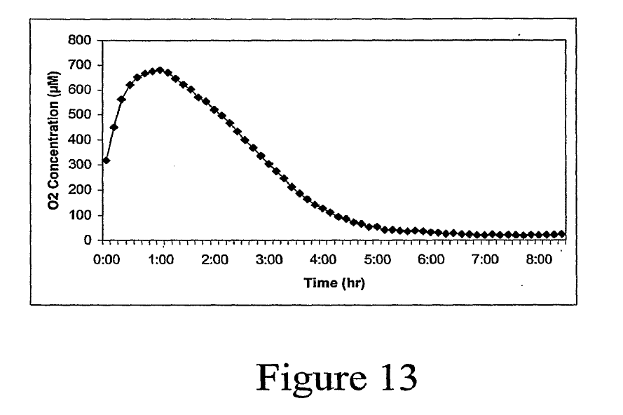

FIG. 12 shows a depletion curve of oxygen by one corn plant grown in 50 ml 200% strength nutrient solution at a three-leaf stage. FIG. 12 shows that the nutrient solution has no ability to provide bioavailable oxygen because the oxygen content went down sharply when one plant was put in the solution. After about 40 minutes, the plant consumed almost all the available dissolved oxygen in the solution. However, the situation was greatly changed when 1 ml 3% H₂O₂ was put into the solution. FIG. 13 shows a depletion curve of oxygen by one corn plant grown in 50 ml 200% strength nutrient solution with one liter of 3% H₂O₂ at three-leaf stage. At the beginning, the oxygen level even increased because catalase on the roots functioned to release more oxygen. The amount of oxygen H₂O₂ supplied to the plant lasted only about 5 hours. This indicates that H₂O₂ did provide some ability to provide bioavailable oxygen, as shown in FIG. 13.

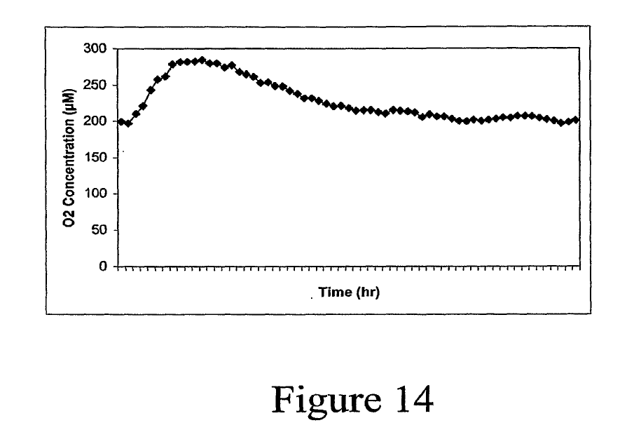

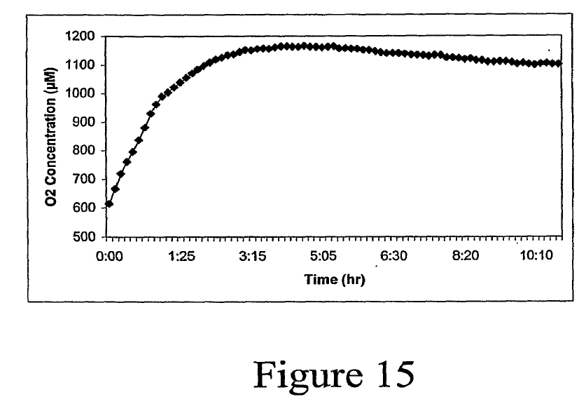

FIG. 14 shows a depletion curve of oxygen by one corn plant grown in 50 ml 200% strength nutrient solution with MgO₂ at three-leaf stage. FIG. 15 shows a depletion curve of oxygen by one corn plant grown in 50 ml 200% strength nutrient solution with CaO₂ at three-leaf stage. FIGS. 14 and 15 are definitely different from FIGS. 12 and 13. The compositions (calcium peroxide and magnesium peroxide) provided to the plants in FIGS. 14 and 15 could maintain oxygen release for much longer periods of time because the insoluble peroxides could release oxygen continuously when oxygen was consumed. Calcium peroxide had much higher level of oxygen than magnesium peroxide because the former one's Kₛₚ is about 3000 times bigger than that of the latter. This indicated that the bigger the Kₛₚ, the bigger the buffering ability.

### Adjustment of the Buffering Ability of the Systems

According to the principle of product solubility, the act of taking away either cations or anions enables accelerated dissolution of insoluble compounds. This is the basis for enabling the adjustment of oxygen release from compositions of the invention. For instance, as noted above, compositions comprising peroxides are less soluble when more companion cations are present and, hence, less oxygen is released and the buffering ability of the composition to provide bioavailable oxygen decreases. Contrary to this, when more oxygen is released, the system becomes a better buffering system as more cations are removed.

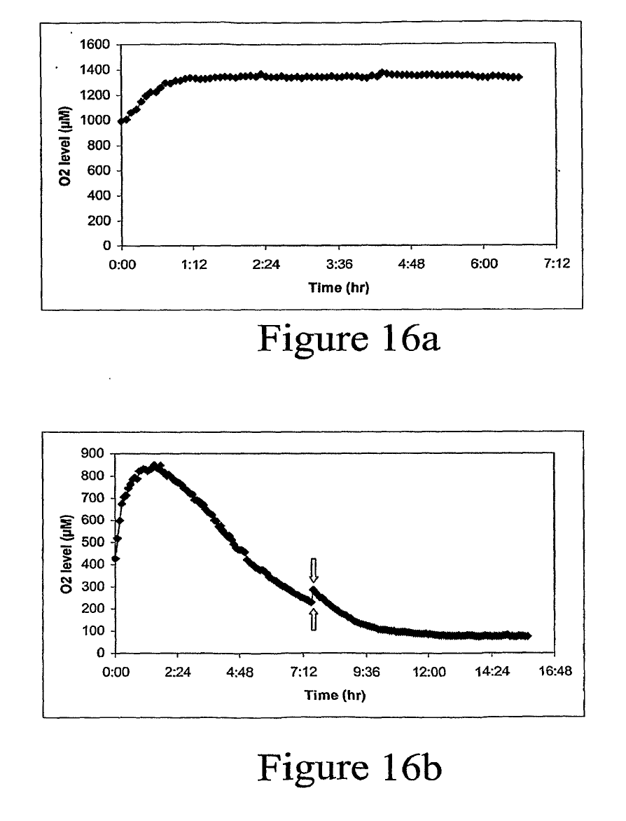

FIG. 16a shows a depletion curve of oxygen by one corn plant grown in 50 ml 50 mM EDTA solution with MgO₂ at three-leaf stage. The companion cations are chelated if some chelators are put into the system. As a result, more sparsely soluble peroxides are dissolved and the system's buffering ability becomes stronger, as shown in FIG. 16a. FIGS. 14 and 16a both show a solution with the same peroxide, magnesium peroxide, in the same volume, 50 ml. But the latter is with 50 mM EDTA. Thus, the latter's oxygen level is much higher than the former's due to chelation by EDTA. Every method that facilitates dissolving the insoluble peroxides is able to increase the buffering ability of the system with sparsely soluble peroxides. Both low pH and bigger bulk volume of the system are able to strengthen the buffering ability. FIG. 16b shows a depletion curve of oxygen by one corn plant grown in 50 ml 10 mM EDTA solution with MgO₂ at three-leaf stage. Oxygen level increases when the plant is off but the level decreases when the plant is on again as the two arrows show.

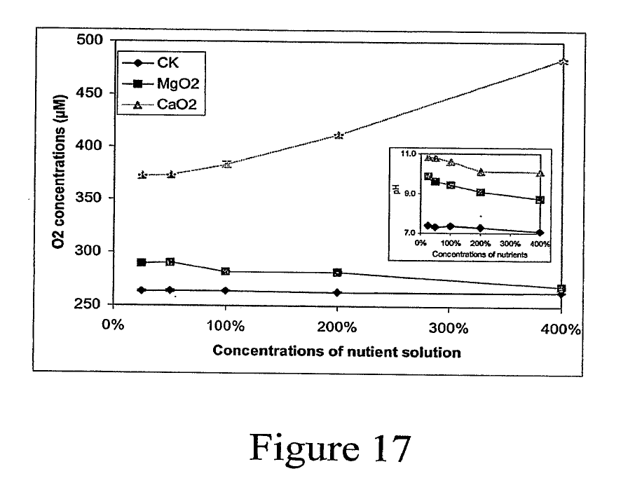

FIG. 17 shows oxygen release of two peroxides in nutrient solution at different concentrations. The only difference between the treatments in FIGS. 16 and 17 is the concentration of EDTA: 50 mM for FIG. 16 but only 10 mM for FIG. 17. However, the oxygen levels between these two are very different. The original oxygen concentration of FIG. 17 is only about 40% of that of FIG. 16. The top concentration also differs greatly. The oxygen level of FIG. 17 is only about 60% of that of FIG. 16. Very interestingly, as shown in FIG. 16, a constant level of oxygen can be released after reaching top level of EDTA concentration. This indicates that the rate of oxygen release could meet the rate of oxygen consumed by the plant at the three-leaf stage. This solution has a very strong buffering ability. But, the oxygen level falls very quickly when it reaches the top level of EDTA concentration. This shows that the consuming rate is over the release rate.

A plant off-on experiment proved this as well. The plant was moved away from the 50 ml solution for 12 hours after 7.5 hours of oxygen consumption. The oxygen level increased about 25%. Then the plant was put back in the solution again. The oxygen level went down until it reached the balance between the two contrary rates. This shows that the buffer ability of the solution in FIG. 17 is much weaker than that of FIG. 16.

### Oxygen-Controlled-Release in Various Strengths of Nutrient Solution

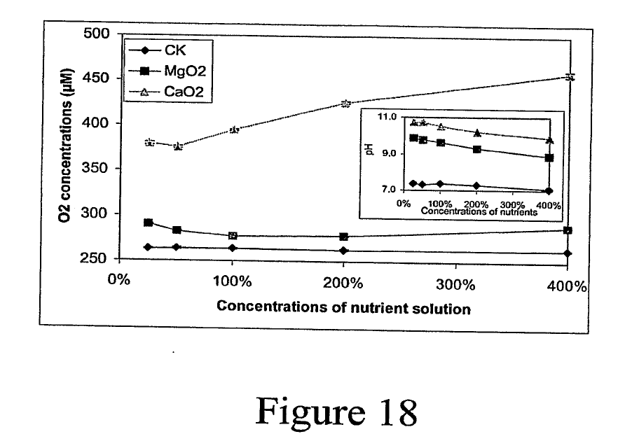

FIG. 18 shows oxygen release of two peroxides in nutrient solution without companion cations at different concentrations. As FIGS. 17 and 18 show, both of the peroxides dissolve partially in different strengths of nutrient solutions. The oxygen levels of the solutions with either of the peroxides are higher than those of the control without any peroxides. For magnesium peroxide, its oxygen level is very smooth when the nutrient strength increases whether the nutrient solution was with or without the companion cations of the peroxide. But for calcium peroxide, the oxygen level increases when the nutrient strength increases under both situations with or without companion cations.

The pH values of the solutions decrease as the nutrient strength increases because the more concentrated the nutrient solution, the stronger the pH buffering ability of the solutions. Additionally, more companion cations are able to precipitate more hydroxides and hence, the pH decreases as aforementioned.

### Differences in Oxygen Level of Different Oxygen Sources in Pot Experiments

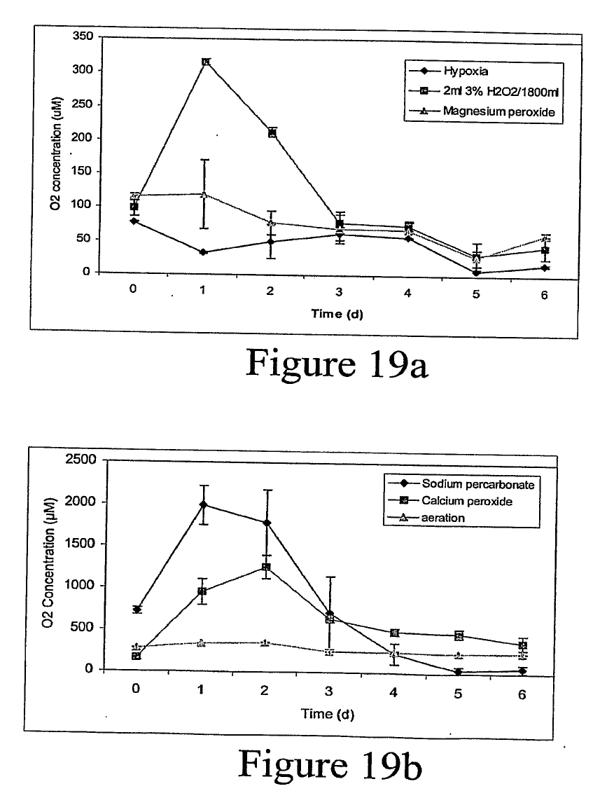

FIG. 19a shows changes of oxygen level in different solutions of one plant grown from the three-leaf stage on. FIG. 19b shows changes of oxygen level in other different solutions of one plant grown from the three-leaf stage on. FIGS. 19a and 19b show that the oxygen levels in the solutions with different oxygen sources vary greatly. For the hypoxic treatment, oxygen levels in a newly prepared nutrient solution without any oxygen sources added were able to maintain about 50 μM oxygen that was the result of the dynamic equilibrium between plant oxygen consuming and dissolving by the surface area of the pot mouth. As mentioned before, the air-saturated water has about 250 μM bioavailable oxygen if no oxygen is consumed. However, the roots of corn seedlings grown in the culture solution need to use oxygen to sustain their metabolism and generate active energy: ATP. Therefore, 5 the actual oxygen level in the solution is the results of the dynamic equilibrium between oxygen dissolved and oxygen consumed.

The greater the root surface area, the smaller the hypoxic stress experienced by the plant. The oxygen level released provided by magnesium peroxide was consistent and much higher than the hypoxic treatment and even higher than the treatment with hydrogen peroxide. However, its oxygen level was not high enough for the plant in this experiment. The H₂O₂ treatment was very fluctuant in its level of oxygen released because of its reaction with the enzyme, catalase. Its high oxygen level lasted only for two days because its total amount of oxygen was limited.

The curve of sodium percarbonate is very similar to that of hydrogen peroxide but the level of oxygen released is much higher because the oxygen amount in 2 g of sodium percarbonate is much more than that of 2 ml 3% hydrogen peroxide (FIG. 19b). Calcium peroxide has a single peak on day 2 and is able to maintain double the oxygen level of aerating treatment. Again, this shows that calcium peroxide serves as a much stronger buffer in the release of bioavailable oxygen than magnesium peroxide because the former has a much higher solubility than the latter. The curve for aeration was pretty smooth throughout the duration of the experiment.

### Rescue of Oxygen-Controlled-Release Systems to Corn Seedlings Flooded

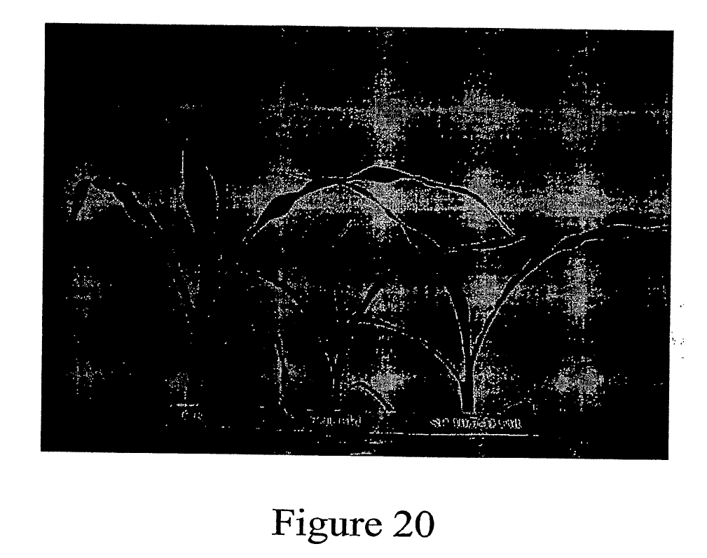

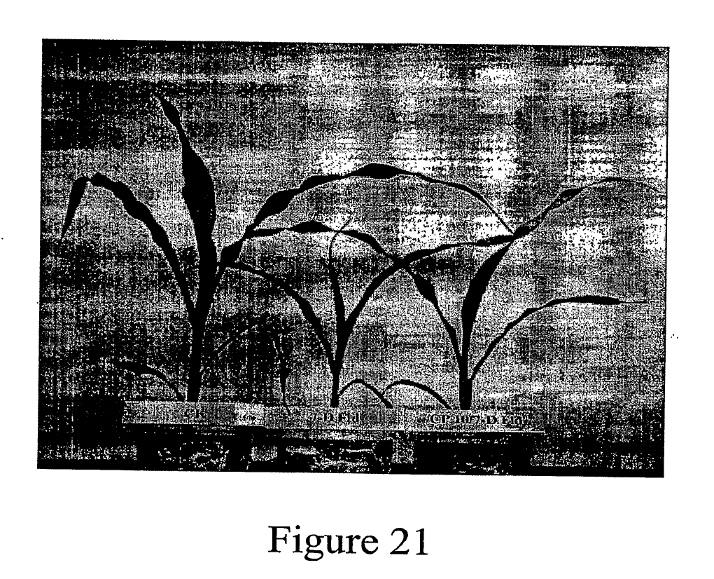

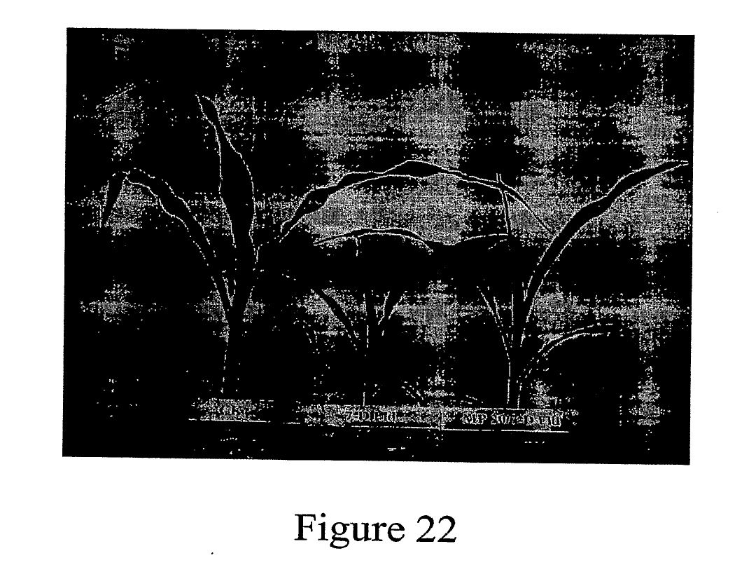

After 10 days of growth in soil in a normal environment, the plants were flooded with different treatments. FIG. 20 shows the differences in growth of flooded corn plants with or without peroxides. CK=control, 7-D Fld=flooded for 7 days, SP 10/7-D Fld=flooded for 7 days with 10 g sodium percarbonate. FIG. 21 shows the differences in growth of the flooded corn plants with or without peroxides. CK=control, 7-D Fld=flooded for 7 days, CP 10/7-D Fld=flooded for 7 days with 10 g calcium peroxide. FIG. 22 shows the differences in growth of flooded corn plants with or without peroxides. CK=control, 7-D Fld=flooded for 7 days, MP 20/7-D Fld=flooded for 7 days with 20 g magnesium peroxide.

FIGS. 20-22 show that all the treatments that were flooded for 7 days with peroxides were much better than those samples placed in flooded conditions without the peroxides. Such results implied that all of the compositions comprising oxidizing agents (including solid compositions) were able to alleviate flooded stress.

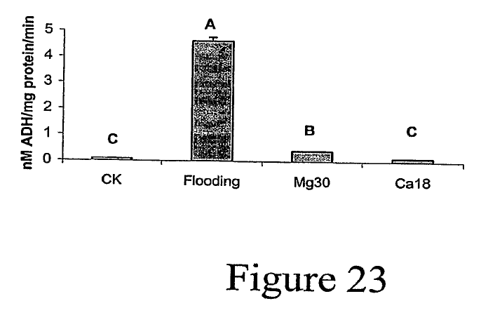

FIG. 23 shows ADH levels of different oxygen status. All were flooded for 3 days after transplanting except the control. Mg30 indicates 30 g magnesium peroxide per pot. Ca18 represents 18 g calcium peroxide per pot. The columns with different uppercases differ very significantly (p<0.01). FIG. 23 shows that the more solid composition comprising an oxidizing agent, sodium percarbonate (SP), calcium peroxide (CP), or magnesium peroxide (MP) was used, the less ADH activity observed in the tested roots. This proved that solid compositions comprising an oxidizing agent were able to alleviate the hypoxic situation in which corn plants were grown.

Among these three types of solid compositions, SP is soluble and supplies current bioavailable oxygen to plants and to other organisms. However, the supply lasts for only a short period of time and therefore is not ideal for a controlled release system of oxygen. CP and MP are both insoluble but the former is more soluble than the latter. Hence, they are able to construct a controlled release system of oxygen (also referred to herein as an oxygen buffer system). They can last up to six months. Based on the above figure, 18 g of CP per pot functioned best. This one was almost as good as the control. However, 5 g of SP was almost as bad as the flooded treatment without the supply of solid compositions. The data suggested that 18 g of CP supplied enough oxygen to corn plants during this flooded period of time.

### pH Control of the Oxygen-Release-Systems With Solid Compositions of the Invention

The results from this example show that peroxides with calcium or magnesium are able to supply oxygen-release-systems. The level of released oxygen depends on their solubility products. Each insoluble peroxide has its own unique solubility product that cannot be changed. But their ion products are changeable and this is the basis of the control of the oxygen-release-system.

Compositions of the invention can be altered by adding companion cations or reducing companion cations (by adding chelators) to control the release of oxygen. Besides this adjustment, pH can also change ion products and hence, change the level of oxygen-release from compositions of the invention. However, pH control is not as simple as adding or reducing companion cations to the nutrient solution because the insoluble peroxide can keep dissolving after adding dilute acid to adjust the pH around the neutral value and then when the pH is raised up again. Also, adjustment of pH is required daily. Thus, a dynamic adjustment of pH in the nutrient solution is preferred.

According to the property of plant nutrition, the adjustment of the ratio of cations to anions in a nutrient formula can assist in regulating the level of nutrients and toxins in plant cells. Plant vacuolar transporters, such as antiporters and symporters, appear to provide an important mechanism for ion sequestration and secondary active uptake of nutrients.

An antiporter is an integral membrane protein that is involved in secondary active transport of nutrients. It works by binding to one molecule of solute outside the membrane, and one molecule on the inside of the membrane. A symporter, also known as a coporter, is an integral membrane protein that is involved in secondary active transport of nutrients. It works by binding to two molecules at a time and using the gradient of one solute's concentration to force the other molecule against its gradient.

For example, when a symporter sequesters an NH₄⁺ ion, a plant would either take one OH⁻ or HCO⁻₃ (through symporter) or extrude one H⁺ (through an antiporter) in order to keep electrical neutrality in its cells. The net result of either by symporter or by antiporter is the same: the medium is acidified and hence the pH level goes down. Contrary to that, pH of growth medium grown plants will go up when the grown plants uptake anionic nutrients such as a nitrate in the same principle.

Nitrogen is one of the most important macronutrients and has two different forms: oxidized form (such as NO₃⁻) and reduced form (such as NH₄⁺). Thus, pH of the growth medium can be controlled by adjusting the ratio of cations (ammonium) to anions (nitrate) in the nutrient formula. In other words, more ammonia and fewer nitrates in the nutrient solution will neutralize alkalinity from the peroxide. Sparsely soluble peroxides may be a very useful oxygen source when the pH can be freely controlled in solution. Another possible way to control the pH value is to use a controlled release system of phosphate as a P source by using a sparsely soluble phosphate.

As for soil culture, whether appropriate pH levels are present is not as much of an issue because natural soil consists of a complex chemical system and hence is a very good buffer to some extent.

### Adjustments of Buffering Ability by Using Mixed Insoluble Solid Compositions of the Invention

As mentioned before, calcium peroxide has a 3000 times higher Kₛₚ than magnesium peroxide. Thus, the former is much more soluble than the latter. Calcium peroxide has a very rapid initial release on the first day but then later locks up for about two weeks. After that, the pressure breakthrough of “lock-up” coating with rapid release results in product exhaustion. But the release behavior of magnesium peroxide is rather different from calcium peroxide. In the first six days, it obeys the first order release law and releases 10% oxygen while the other 90% oxygen is released based on zero order constant release. These properties of the two peroxides show that their chemical behaviors are complementary even though oxygen release from magnesium peroxide is much slower than that of calcium peroxide. Therefore, the mixture of the both peroxides may better their properties in oxygen release.

### EXAMPLE 3

### Materials

Corn seeds, FR27 x FRMO17, are from Illinois Foundation Seeds, Inc. All of the chemicals were from Sigma-Aldrich except for the “oxygen fertilizers”: magnesium peroxide (Oxygen Fertilizer 1) and calcium peroxide (Oxygen Fertilizer 2), both of which were provided by Solvary Interox, Inc., and the 3% hydrogen peroxide, which was from Wal-Mart.

### Oxygen Solution or O₂ Fertilizer Preparation

One hundred milligrams of each of the above solid compositions was put in a 50 ml polypropylene tube, respectively, unless specialized. 50 ml de-ionized water or nutrient solution was put into the tubes. The strength of the nutrient solutions was 25%, 50%, 100%, 200% or 400% of Yan's formula (Yan, F. et al., “Adaptation of active proton pumping and plasmalemma ATPase activity of corn roots to low root medium pH,” Plant Physiology, 117:311-319 (1998)). The oxygen solutions were allowed to equilibrate overnight before any measurements were made.

### Culture Methods

All of the seeds were germinated and grown in aeroponics in Yan's recipe (Yan, F. et al., “Adaptation of active proton pumping and plasmalemma ATPase activity of corn roots to low root medium pH,” Plant Physiology, 117:311-319 (1998)) but with Si (as sodium silicate) (Epstein E., “The anomaly of siliconin plant biology,” Proc Natl Acad Sci USA. 91:11-17 (1994)) at 25° C. during a 16-hour daytime and at 22° C. at an 8-hour nighttime, 60% relative humidity and at a light density of 550 μmol photon m⁻² s⁻¹ (PAR) in the growth cabinet made by Percival Scientific, Inc.

### Analysis for Kinetics of O₂ Release From Sparsely Soluble Oxygen

After one week's growth, the corn seedlings reached the three-leaf stage and a single seedling was placed into the 50 ml oxygen solution with 200% strengths of nutrients. The oxygen content in the solution was measured and recorded every 5 minutes or specialized. The seedling was illuminated by a Fiber light source (Model 180, 2000 W, Dolan-Jenner Industries, Inc.) at a light density of 210 μmol photon m⁻²s⁻¹ (PAR).

### Oxygen Analysis

Oxygen contents in solution were determined with oxygen electrode and ASET system (Applicable Electronics, Inc). Calibration was made by nitrogen aerating deionized water and air equilibrated deionized water. The deionized water consists of 0% oxygen level and the air equilibrated deionized water consists of 21% oxygen content. The temperature of the deionized water was measured and recorded for every measurement. The actual oxygen content in the deionized water at the temperature was found out from a handbook of chemistry (David R. Lide, Handbook of Chemistry and Physics, 79^{th} Edition, 1998-1999, pp. 8-87). A regressive equation was formed by data from calibration and the handbook. All the observed values were changed into oxygen contents in micromoles through the regressive equation.

### ADH Activity

The enzyme assay was performed according to the procedures described by Chung and Ferl (“Arabidopsis Alcohol Dehydrogenase Expression in Both Shoots and Roots Is Conditioned by Root Growth Environment,” Plant Physiol, 121:429-436 (1999)) and modified slightly. ADH and NR were extracted in the same extraction buffer including 50 mM Tris-HCl (pH 8.0), 1 mM EDTA, 12 μM mercaptoethanol, and 0.05 mg DTT/ml. Frozen root tissues were ground rapidly in a chilled mortar and pestle with the above chilled extraction buffer. The homogenate was centrifuged at 15 000 g at 4° C. for 15 minutes. One hundred μl of supernatant was added to 800 μl of reaction solution containing 50 mM Tris-HCl buffer at pH 9.0, 1 mM EDTA, and 1 mM NAD. The assay uses 15% (v/v) ethanol as the substrate and measures the production of NADH. Measurement of NADH formation was performed in a spectrophotometer (DU 64, Beckman Instruments, Fullerton, Calif.) for 60 seconds at 340 nm. A unit of ADH is defined as the production of 1 nmol of NADH min⁻¹ mg⁻¹ protein.

### NR Activity

NR assays were performed essentially as described by the protocol of Datta and Sharma (Rupali Datta and Rameshwar Sharma, “Temporal and spatial regulation of nitrate reductase and nitrite reductase in green maize leaves,” Plant Science, 144:77-83 (1999)). NR activity was measured immediately. 200 μl of supernatant was added to 800 μl of reaction solution consisting of 50 mM Tris-HCl buffer (pH 8.0), 1 mM EDTA, 100 μM NADH, 10 mM KNO₃ and 1 μM Na₂MoO₄ in a 2 ml eppendorf tube. The reaction was performed in a water bath of 30° C. and terminated after 60 min by adding 500 μl of an equal volume of sulfanilamide (1% [w/v] in 3 n HCl) and naphthylethylene-diamine dihydrochloride (0.05% [w/v]) to the reaction mixture. The samples were colorimetrically measured at 540 nm. One unit of NR activity was defined as the amount required to produce 1 nmol of nitrite min⁻¹ mg⁻¹ protein.

### Protein Measurements Assay

Protein contents of the samples were colorimetrically determined according to Lowry's method (Lowry O H et al., “Protein measurement with the Folin phenol reagent,” J Biol Chem 193:265-275 (1951); Peterson G, “A simplification of the protein assay method of Lowry et al., which is more generally applicable,” Analytical Biochem. 83:346-356 (1977)). 10 μl of supernatant was mixed with 990 μl Lowry A: equal volumes of copper-tartrate-carbanate (CTC) solution consisting of 0.1% CuSO_{4.5}H₂O, 0.2% NaK-tartrate and 10% NaCO₃; 10% sodium dodecyl sulfate (95% SDS, sigma # L-5750); 0.80 N NaOH and deionized water and 15 min later, 500 μl Lowry B (one part of 2.0 N Folin & Ciocalteu's Phenol Reagent Solution (Sigma # F-9252) was diluted in 5 parts of deionized water) was added. Bovine Serum Albumin (BSA, Sigma # A-2153) was used to prepare the standards.

The measurements were all performed in triplicate.

### Microelectrode Fabrication

Each of the untreated 1.5 mm borosilicate glass capillaries (cat no. TW150-4) of 10 cm length was pulled into two micropipettes through a Sutter P-97 at 545° C. The freshly pulled micropipettes were silanized at 200° C. with N,N-Dimethyltrimethylslylamine according to Smith's method (Smith, P J S et al., “Self-referencing, non-invasive, ion selective electrode for single cell direction of trans-plasma membrane,” Microscopy Research and Technique, 46:398-417 (1999)).

The micropipettes were backfilled with a H⁺ probe backfilling solution of 50 mM KCl and 50 mM HK₂PO₄. Then hydrogen ionophore I—Cocktail B (cat no. 95293, Fluke Chemika, Switzerland) was drawn into the tip with a minimal negative pressure under a binovular compound microscope as described by Smith et al. (“Self-referencing, non-invasive, ion selective electrode for single cell direction of trans-plasma membrane,” Microscopy Research and Technique, 46:398-417 (1999)).

### Measurements of Net Ion Fluxes

A rubber groove of 20 cm in length, 5 cm in width, and 1 cm in height was connected to the pot with 1800 ml nutrient solution via a peristaltic pump (Model: 77120-62, 12 VDC 1 AMP, Mfg by Barnant Company) and non-permeable oxygen tubing. One radicle root was appropriately stabilized in the groove with 4 to 5 Minucie stainless-steel needles. Microelectrodes were calibrated before and after each experiment. Calibrations were done in standard pH 6, 7, and 8 solutions (Fisher Scientific) at 25° C. The Nernst Slopes (in mV decade⁻¹) were equal or close to 59. Following calibration, the microelectrode was positioned on the targeted radicle root. The scanning started from the root tip and the root was scanned 100 μm by 100 μm near the root tip. Then the scanning intervals were adjusted gradually from 200 μm to 1000 μm or even longer. About 20000 μm along the root was scanned. Before every measurement, the peristaltic pump ran for about 30 min. in order to balance the solution. The plant was standing in a plastic box with its culture solution and was illuminated by a Fiber light source (Model 180, 2000 W, Dolan-Jenner Industries, Inc.) at a light density of 210 μmol photon m⁻²s⁻¹ (PAR).

### RNA Isolation and Northern Hybridizations

Total RNA from maize roots was extracted according to the method described previously by Chang et al. (1993). The RNA was blotted onto nitrocellulose membranes by capillary action (Sambrook et al., 1989). The probe used for hybridization was maize ADH1 cDNA (a gift from Dr. Julia Bailey-Serres, University of California-Riverside) and northern hybridization was also performed as described previously by Sambrook et al. (1989), with the exception that DNA fragments were labeled with an AlkPhos-direct kit (Amersham Pharmacia Biotech) and signals were detected by CDPstar chemiluminescence.

### Results and Analyses

### Oxygen Supplying Capability of Fertilizers Comprising Oxidizing Agents

FIG. 12 shows that the bioavailable oxygen content in a normal, commercial nutrient solution falls sharply when a plant is placed in the solution. After about 40 minutes, the plant consumed almost all of the bioavailable oxygen dissolved in the solution. However, the situation was greatly changed when 1 ml 3% H₂O₂ was put into the solution (FIG. 13). At the beginning, the oxygen level even increased because the catalase on the roots functioned to release more oxygen. The amount of oxygen H₂O₂ supplied to the plant lasted for only about 5 hours in this experiment. These results indicate that the H₂O₂ did not have much of an ability to buffer the oxygen supply as the seedling kept consuming oxygen.

FIGS. 14 and 15 are definitely different from FIGS. 12 and 13. A very high oxygen level was maintained for a much longer period of time when using insoluble peroxides (see FIGS. 14 and 15) because insoluble peroxides could release oxygen continuously after the oxygen was consumed. For example, calcium peroxide had a much higher level of oxygen release than magnesium peroxide because the former's Kₛₚ is about 3000 times greater than that of the latter. This indicated that the greater the Kₛₚ value, the greater the buffering ability for supplying oxygen.

### Time Course of Changes in ADH and NR of Corn in Hypoxia

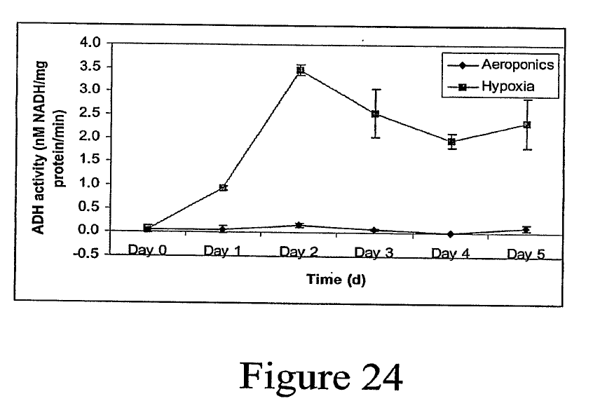

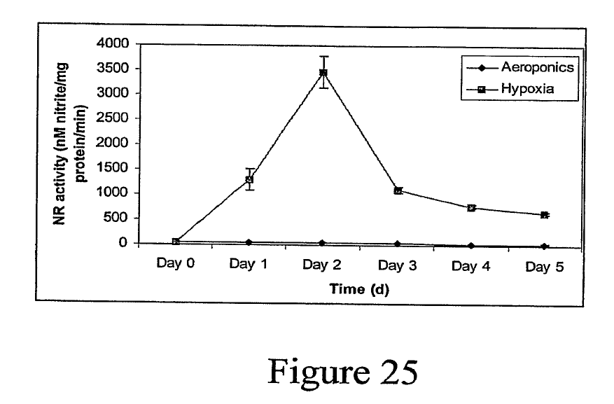

ADH and NR were both very low when the seedlings had a sufficient oxygen supply. However, under hypoxia, corn plants. synthesized the anaerobic polypeptides (ANPs), such as ADH and NR, greatly (Sachs et al, 1980, Dennis et al, 2000). FIG. 24 shows the time course of relative ADH activity of corn seedlings suffering from hypoxia. It shows that under hypoxic stress, day 2 is the peak time for alcohol dehydrogenase activity. FIG. 25 shows the time course of relative NR activity of corn seedlings suffering from hypoxia. It shows that under hypoxic stress, day 2 is the peak time of nitrate reductase activity. Both the ADH and NR increased dramatically at the beginning and reached their peaks on the second day after the plants suffered from hypoxia (FIGS. 24 and 25). This suggests that both the ANPs are time-dependent and shows that the first two days are when the corn seedlings are most sensitive to hypoxia. At the beginning of hypoxia, bioavailable oxygen drops linearly because the plants consume oxygen at a normal rate and the plants suffering from hypoxia have not yet become accustomed to the low oxygen bioavailability. Then, the activities of the two enzymes drop because it appears the plants begin to adapt to the low oxygen environment. The growth of the tested plants also decreases. These results suggest that other physiological and biochemical measurements can be performed during that period.

### Effects of Oxygen Fertilizers on ADH and NR Activities

Gases diffuse about 10,000 times more slowly through water than through air (Holbrook, M. N. and M. A. Zwienieckl, “Water Gate,” Nature, 425:361 (2003)). Accordingly, when roots are suspended in flooded or waterlogged soils, they quickly become exposed to conditions of low oxygen bioavailability. With the compositions of the subject invention, oxygen is readily deliverable and applicable in such situations.

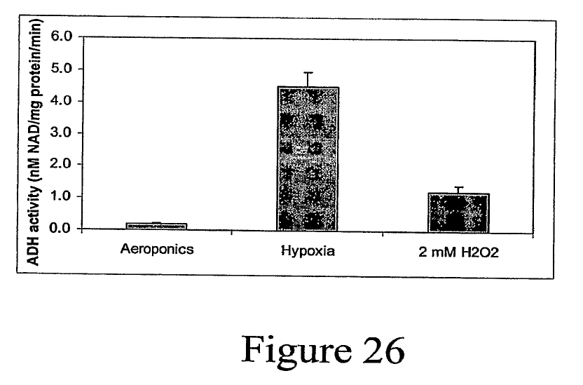

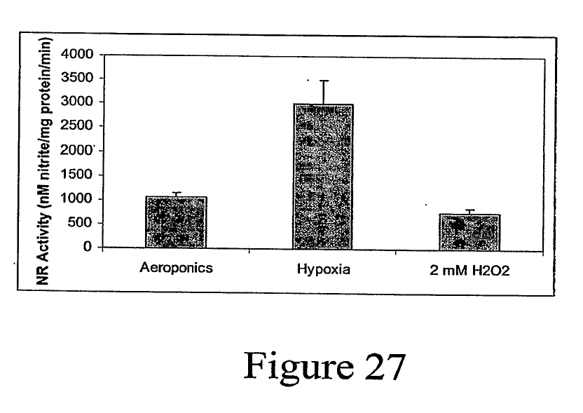

FIG. 26 shows ADH activity of corn seedlings with or without hydrogen peroxide. FIG. 27 shows NR activity of corn seedlings with or without hydrogen peroxide. In this example, when one corn seedling is grown in a nutrient solution of 2 mM hydrogen peroxide, the ADH (FIG. 26) and NR (FIG. 27) levels are both greatly lower than those of hypoxic seedlings even though the ADH level of the seedling placed in hydrogen peroxide was slightly higher that that of the control.

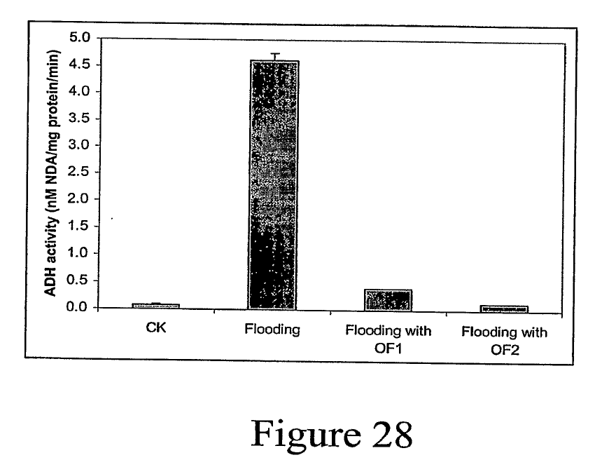

FIG. 28 shows the effects of oxygen fertilizers (OF) 1 and 2 on ADH activity of corn seedlings grown in soil in pots. Similarly, either of “solid” OF1 or OF2 greatly lowered the ADH of the seedlings suffering from flooding in the pot experiment. These “liquid” or “solid” oxygen fertilizers could deliver oxygen in soil or in nutrient solutions and release bioavailable oxygen around or in the rhizesphere. The enzyme analysis indicates that the oxygen fertilizers could supply bioavailable oxygen for the plants and mitigate the hypoxic situation.

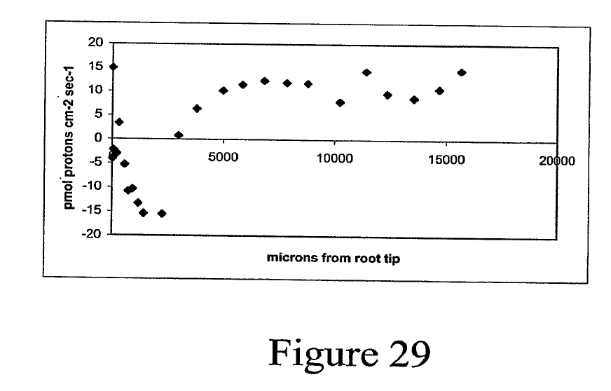

Oxygen is vital to plant life. Under oxygen deficiency, plant roots responded very quickly with appropriate metabolic processes. FIG. 29 shows proton extrusions on corn root under annoxia. Corn seedlings were grown in aeroponics for 5 days and then in hypoxic nutrient solution for two days before scanning. The root was scanned in the hypoxic solution with N2 bubbling. In the absence of oxygen, proton extrusions from roots were very small because normal aerobic respiration switched to anaerobic respiration, resulting in a decrease in proton efflux rate along the roots.

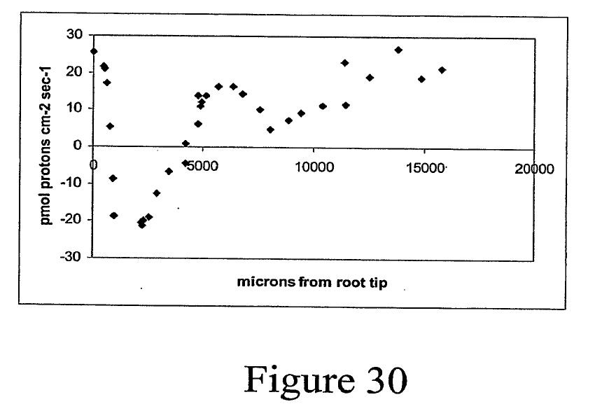

FIG. 30 shows proton extrusions on corn root under hypoxia. Corn seedlings were grown in aeroponics for 5 days and then in hypoxic nutrient solution for two days before scanning. The root was scanned in the hypoxic solution without N2 bubbling. Similarly, only a very small amount of protons were extruded from the root when the plant suffered from low bioavailable oxygen.

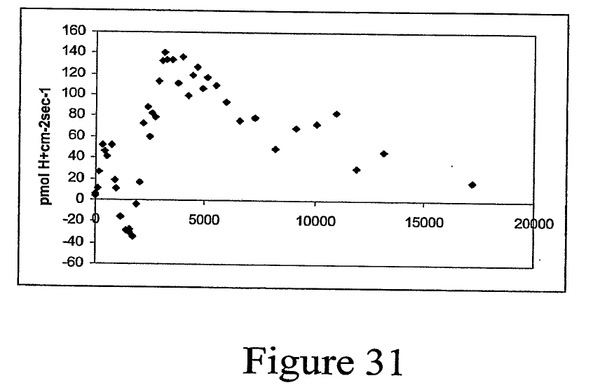

FIG. 31 shows proton extrusions on corn root under normoxia. Corn seedlings were grown in aeroponics for 5 days and then in nutrient solution with 1 mM H₂O₂ for two days before scanning. The root was scanned in the normoxia solution with air bubbling. The roots under normal oxygen conditions could excrete seven to ten times more protons than those under hypoxia or anoxia (FIGS. 29, 30, 31).

Among the three different statuses of oxygen bioavailability, the greatest variance in proton influx occurred on the first 5000 microns from the root tips. The first 3000 to 4000 microns had a similar amount of proton influxes under hypoxia or anoxia even though there was little proton influx on the first 1000 microns of the root from the tip under normal oxygen conditions. Because every root has a root cap to protect the root tip, there was almost nothing on the root tip indicating receipt of sufficient bioavailable oxygen. However, the tips that suffered from oxygen deficiency had a lot of proton effluxes because the caps might have been leaky (FIGS. 29,30,31).

### Proton Extrusion and Oxygen Bioavailability

Proton extrusion on roots is an adaptative response of plants to stresses. For example, roots extrude protons when plants are suffering from iron deficiency (Hordt et al., “Fusarinines and dimerum acid, mono- and dihydroxamate siderophores from Penicillium chrysogenum, improve iron utilization by strategy I and strategy II plants,” Biometals, 13(1):37-46 (2000)) or phosphorus shortage (Liu et al., “Tomato phosphate transporter genes are differentially regulated in plant tissues by phosphorus,” Plant Physiol. 116(1):91-9 (1998)). However, proton extrusion on roots under hypoxia or anoxia is different from other situations. The quantity of proton extrusions under low oxygen bioavailability was much smaller that that in normoxia (FIGS. 29, 30 and 31) because the plant's metabolic strength was much lower. Furthermore, roots under anoxia extruded less protons than those under hypoxia (FIGS. 29 and 30). Extruded protons on roots under hypoxia were much fewer than that in normnoxia (FIGS. 30 and 31).

The results from this example suggest that proton extrusion associated positively with oxygen bioavailability. Also, there was a large influx of protons from the tip to 3000 or 4000 microns along the suffered root even though there was little influx of protons near the root tip under normoxia. This may be a protective response of the roots under hypoxia or anoxia because the suffering plants need to lower the pH inside the cells in order to decrease root permeability to water under low oxygen levels (Holbrook, M. N. and M. A. Zwienieckl, “Water Gate,” Nature, 425:361 (2003); Tournaire-Roux et al., “Cytosolic pH regulates root water transport during anoxic stress through gating of aquaporins,” Nature, 425:393-397 (2003)). In fact, the water channel activity of purified plasma membrane vesicles can be blocked by protons (Gerbeau et al., “The water permeability of Arabidopsis plasma membrane is regulated by divalent cations and pH,” Plant J., 30(1):71-81 (2002)). Therefore, FIGS. 29, 30, and 31 illustrate new evidence that root permeability to water is downregulated in response to low oxygen levels (Holbrook, M. N. and M. A. Zwienieckl, “Water Gate,” Nature, 425:361 (2003); Tournaire-Roux et al., “Cytosolic pH regulates root water transport during anoxic stress through gating of aquaporins,” Nature, 425:393-397 (2003)) via switching the directions of proton extrusions near the root tip, the most active area of metabolism and the most sensitive part to stresses.

### EXAMPLE 4

Bald cypress is a plant of great ecological and economic significance in Florida. However, these tough, tolerant, inexpensive and somewhat idiosyncratic trees are at the heart of a fast-disappearing ecosystem. Flooding and salinity caused by hurricanes have accelerated the disappearance of the species. Five basins were set up to mimic flooding basins to study the effects of a solid composition of the invention on alleviating the impact of flooding and salinity on Bald cypress seedlings. These basins were established by using plastic swimming pools with 185×152×23 cm plastic tubs for the combined treatment of flooding and salinity to bald cypress seedlings.

Five levels of salinity were presented: 0, 2, 4, 6 and 8 ppt in sodium chloride. Three flooding levels were presented: 0%, 50% and 100% root submergence. 0% flooding level consisted of 100% of the pots being above the water surface; 50% flooding level consisted of 50% of the height of the pots being submerged; and 100% flooding level consisted of 100% of the height of the pots being submerged.

Two oxygen bioavailable levels were provided for those seedlings that were fully flooded with 8 ppt salinity: (1) with composition comprising oxidizing agent or (2) without composition comprising oxidizing agent in the potted soil. The water level in the swimming pools was maintained by a Mariotte's Bottle. Survival rates of the potted seedlings were observed and calculated for each of the treatments.

No seedlings died when subjected to 0% and 50% flooding without the presence of a composition comprising an oxidizing agent in the potted soil. However, 25%, 50% and 75% of the seedlings died when subjected to 100% flooding with 4, 6 and 8 ppt salinity, respectively. No seedlings died when treated with compositions of the present invention, in particular when treated with calcium peroxide. These results indicate that the compositions and methods of the subject invention can prevent many plants, such as the Bald Cypress, from becoming ill or dying when subjected to hypoxic stresses (i.e., 100% flooding in salinity concentrations as high as 8 ppt salinity).

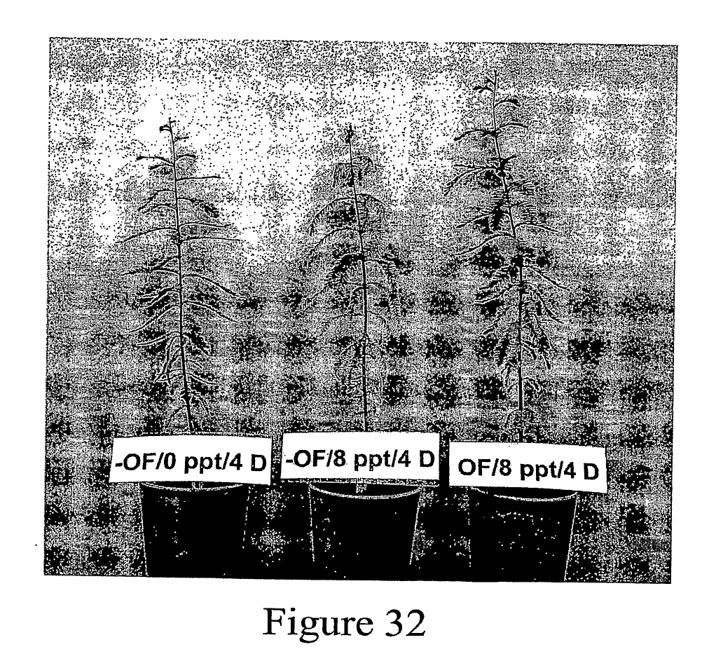

FIG. 32 shows the effect of oxygen fertilizer (OF) on flooded bald cypress with 8 ppt (parts per thousand) salinity (as sodium chloride). The seedlings were all flooded with 100% roots submerged for four days. The seedlings could grow either with 100% roots submerged and without salinity or with 100% roots submerged 8 ppt salinity and oxygen fertilizer (20 g of calcium peroxide per pot). However, the seedlings were dying when their roots were submerged completely with 8 ppt salinity but without oxygen fertilizer. The compositions of the invention are thus advantageous in providing bioavailable oxygen to flooded plants, especially those such as the Bald Cypress, to aid in accelerating restoration and reforestation in the everglades in Florida.

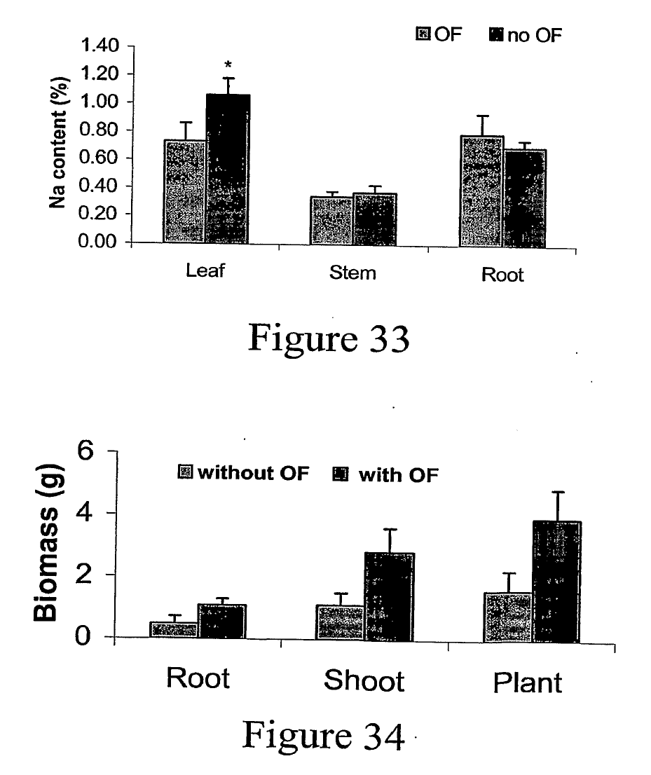

FIG. 33 shows that the slow-release oxygen fertilizer reduced sodium content in leaves significantly (p=0.05). FIG. 34 shows that the slow-release oxygen fertilizer increased biomass remarkably.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

1. A fertilizer composition for application to a seed, plant, growth medium or growth solution comprising an oxidizing agent, wherein bioavailable oxygen is released upon contact of the composition with water.

2. The composition of claim 1 wherein the composition is in liquid form.

3. The composition of claim 2 further comprising a solvent selected from the group consisting of methyl ketone, methyl isobutyl ketone, cyclohexanone, xylenes, toluene, chlorobenzene, paraffins, kerosene, white oil, alcohols, methylnaphthalene, trimethylbenzene, trichloroethylene, N-methyl-2-pyrrolidone and tetrahydrofurfuryl alcohol (THFA).

4. The composition of claim 1 wherein the composition is in solid form.

5. The composition of claim 1 wherein the oxidizing agent is selected from the group consisting of peroxides, superoxides, nitrates, nitrites, perchlorates, chlorates, chlorites, hypochlorites, dichromates, permanganates, persulfates, hydrogen peroxide, magnesium peroxide, peracetic acid, sodium peroxide, sodium percarbonate, potassium peroxide, calcium peroxide, potassium oxide, aluminum nitrate, potassium dichromate, ammonium persulfate, potassium nitrate, barium chlorate, potassium persulfate, barium nitrate, silver nitrate, barium peroxide, sodium carbonate peroxide, calcium chlorate, sodium dichloro-s-triazinetrione, calcium nitrate, sodium dichromate, sodium nitrate, cupric nitrate, sodium nitrite, sodium perborate, lead nitrate, sodium perborate tetrahydrate, lithium hypochlorite, sodium perchlorate monohydrate, lithium peroxide, sodium persulfate, magnesium nitrate, strontium chlorate, magnesium perchlorate, strontium nitrate, strontium peroxide, nickel nitrate, zinc chlorate, nitric acid, zinc peroxide, perchloric acid, calcium hypochlorite, potassium permanganate, chromium trioxide (chromic acid), sodium chlorite, halane, sodium permanganate, trichloro-s-triazinetrione, ammonium dichromate, potassium chlorate, potassium dichloroisocyanurate, sodium chlorate, potassium bromate, sodium dichloro-s-triainetrione, ammonium perchlorate, ammonium permanganate, guanidine nitrate, potassium superoxide, carbamide peroxide, and ozone.

6. The composition of claim 1 further comprising an additive selected from the group consisting of companion cations, cation reducing agents, pH modulators, nutrients, organic compounds, penetrants, microorganisms, pesticides, fungicides, insecticides, nematocides, herbicides, water trapping agents, enzymes, surfactants, wetting agents, spreaders, stickers and growth hormones.

7. The composition of claim 6 wherein the companion cation is selected from the group consisting of Mg²⁺, Mn²⁺, Ca²⁺, Cu²⁺, and Zn²⁺.

8. The composition of claim 6 wherein the cation reducing agent is a chelator.

9. The composition of claim 8 wherein the chelator is selected from the group consisting of water, carbohydrates, organic acids with more than one coordination group, lipids, steroids, amino acids and related compounds, peptides, phosphates, nucleotides, tetrapyrrols, ferrioxamines, ionophores, phenolics, 2,2′-bipyridyl, dimercaptopropanol, Ethylenediaminotetraacetic acid (EDTA), Ethylene glycol-bis-(2-aminoethyl)-N,N,N′ (EGTA), Nitrilotracetic acid (NTA), salicylic acid, and triethanolamine (TEA).

10. The composition of claim 6 wherein the pH modulator is selected from the group consisting of ammonia compounds, nitrate compounds, ammonium phosphate compounds, ammonium nitrate compounds, phosphate compounds, ACES buffers, N-(2-hydroxyethyl)-piperazine-N′-2-ethanesulfonic acid (HEPES buffer), triethanolamine (TEA), MES buffer, ADA buffer, 2-amino-2-methyl-1-propanol (AMP), and 2-amino-2-methyl-1,3-propanediol (AMPD).

11. The composition of claim 6 wherein the nutrient is selected from the group consisting of nitrogen (N), phosphorus (P), potassium (K), calcium (Ca), magnesium (Mg), iron (Fe), zinc (Zn), manganese (Mn), copper (Cu), and boron (B).

12. The composition of claim 6 wherein the organic compound is selected from the group consisting of biosolids, humic acid, fulvic acid, seaweed extracts, kelp extracts, activated sludge, municipal compost, animal manures, and composted organic byproducts.

13. The composition of claim 6 wherein the microorganism is selected from the group consisting of bacteria, fungi, and viruses.

14. The composition of claim 1 wherein the oxidizing agent is a peroxide having a purity of equal to or greater than 50%.

15. A method for preparing a fertilizer composition for application to a seed, plant, growth medium or growth solution, the method selected from the group consisting of mixing an oxidizing agent with a finely divided solid carrier, incorporating an oxidizing agent into a porous granular material and incorporating an oxidizing agent onto a hard core material.

16. The method of claim 15 wherein the oxidizing agent is selected from the group consisting of peroxides, superoxides, nitrates, nitrites, perchlorates, chlorates, chlorites, hypochlorites, dichromates, permanganates, persulfates, hydrogen peroxide, magnesium peroxide, peracetic acid, sodium peroxide, sodium percarbonate, potassium peroxide, calcium peroxide, potassium oxide, aluminum nitrate, potassium dichromate, ammonium persulfate, potassium nitrate, barium chlorate, potassium persulfate, barium nitrate, silver nitrate, barium peroxide, sodium carbonate peroxide, calcium chlorate, sodium dicloro-s-triazinetrione, calcium nitrate, sodium dichromate, sodium nitrate, cupric nitrate, sodium nitrite, sodium perborate, lead nitrate, sodium perborate tetrahydrate, lithium hypochlorite, sodium perchlorate monohydrate, lithium peroxide, sodium persulfate, magnesium nitrate, strontium chlorate, magnesium perchlorate, strontium nitrate, strontium peroxide, nickel nitrate, zinc chlorate, nitric acid, zinc peroxide, perchloric acid, calcium hypochlorite, potassium permanganate, chromium trioxide (chromic acid), sodium chlorite, halane, sodium permanganate, trichloro-s-triazinetrione, ammonium dichromate, potassium chlorate, potassium dichloroisocyanurate, sodium chlorate, potassium bromate, sodium dichloro-s-triainetrione, ammonium perchlorate, ammonium permanganate, guanidine nitrate, potassium superoxide, carbamide peroxide, and ozone.

17. The method of claim 15 further comprising adding an additive selected from the group consisting of a companion cation, cation reducing agents, pH modulators, nutrients, organic compounds, penetrants, microorganisms, pesticides, fungicides, insecticides, nematocides, herbicides, water trapping agents, enzymes, surfactants, wetting agents, spreaders, stickers and growth hormones.

18. The method of claim 15 wherein the finely divided solid carrier is selected from the group consisting of natural clays, kaolin, pyrophyllite, bentonite, alumina, montmorllonite, kieselguhr, chalk, diatomaceous earths, calcium phosphates, calcium and magnesium carbonates, sulfur, lime, flours, and talc.

19. The method of claim 15 further comprising adding an agent selected from the group consisting of aliphatic and aromatic petroleum solvents, alcohols, polyvinyl acetates, polyvinyl alcohols, ethers, ketones, esters, dextrins, sugars, vegetable oils, emulsifying agents, wetting agents and dispersing agents.

20. A method for promoting seed germination or plant growth, wherein the method comprises administering to a seed, plant, growth medium or growth solution a fertilizer composition comprising an oxidizing agent, wherein bioavailable oxygen is released upon contact of the composition with water.

21. The method of claim 20 wherein the fertilizer composition is administered in a form selected from the group consisting of a dusting powders, wettable powders, granules, emulsifiable or suspension concentrates, liquid solutions, emulsions, seed dressings, microencapsulated granules or suspensions, soil drenches, dips, irrigation components, or foliar sprays.

22. The method of claim 20 wherein the fertilizer composition is administered by dusting.

23. The method of claim 20 wherein the fertilizer composition is administered by spraying.

24. The method of claim 20 wherein the fertilizer composition is administered by incorporation of granules.

25. The method of claim 20 wherein the seed or plant is a crop selected from the group consisting of cereals, legumes, brassicas, cucurbits, root vegetables, sugar beet, grapes, citrus, fruit trees, soft fruits, corn, peas, oil seed rape, carrots, spring barley, avocado, citrus, mango, coffee, deciduous tree crops, grapes, strawberries, berries, soybeans, broad beans, beans, tomato, cucurbitis and other cucumis species, lettuce, potato, sugar beets, peppers, sugar cane, hops, tobacco, pineapples, coconut palms, palms, rubber plants and ornamental plants.
